(19) United States
(12) Patent Application Publication
(10) Pub. No.: US 2010/0332679 A1
(43) Pub. Date: Dec. 30, 2010

(54) FRAME RELAY DEVICE AND FRAME RELAY METHOD

(75) Inventor: Daisuke FURUTA, Fukuoka-shi (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/813,901

(22) Filed: Jun. 11, 2010

(30) Foreign Application Priority Data
Jun. 30, 2009 (JP) 2009-156344

(51) Int. Cl. G06F 15/16; G06F 13/00

(52) U.S. Cl. 709/236; 710/34

(57) ABSTRACT

A communication relay device includes a memory that stores a flooding destination address in advance separately from a learning table. When a source address received from a terminal is learned, the communication relay device determines whether the source address matches the stored destination address of the terminal, and when these addresses match each other, causes the matching source address to be learned more preferentially than other source addresses.

### CROSS-REFERENCE TO RELATED APPLICATION(S)

This application is based upon and claims the benefit of priority of the prior Japanese Patent Application No. 2009-156344, filed on Jun. 30, 2009, the entire contents of which are incorporated herein by reference.

### FIELD

The embodiments discussed herein are directed to a frame relay device and a frame relay method.

### BACKGROUND

Conventionally, a relay device for Ethernet communication acquires a source address (hereinafter, SA) at the time of receiving a frame from a terminal, and the relay device includes a learning table that stores the acquired SA in association with each port.

The relay device then uses the learning table to perform communication control between terminals. The relay device is specifically explained below with reference to FIG. 26. FIG. 26 is a schematic diagram for explaining a conventional communication relay device.

An Ethernet relay device 50 depicted in FIG. 26 (hereinafter, simply “the communication relay device 50”) is a device that relays frames between terminals, and includes a communication interface 51, uplink reception-side buffers 52a to 52z, a source address (SA) extracting unit 53, an uplink transmission-side interface 54, a learning-request queuing first-in first-out (FIFO) 55, a learning table 56, a learning table controller 57, a downlink reception-side interface 58, a destination address (DA) extracting unit 59, a destination searching unit 60, an output-destination port controller 61, and downlink transmission-side buffers 62a to 62z.

The communication interface 51 performs transmission and reception of frames to and from a terminal group (not depicted) connected to the communication relay device 50, and includes physical ports 51a to 51z.

The physical ports 51a to 51z indicate ports physically provided in the communication relay device 50. Each of the ports is allocated with a number. For example, each of the ports has its specific number in the communication relay device 50, such that 1 is allocated to the physical port 51a, 2 is allocated to the physical ports 51b and so on, and 25 is allocated to the physical port 51y, and 26 is allocated to the physical port 51z. In the following explanations, these numbers of the respective ports are referred to as port numbers.

Upon reception of a frame from a terminal, the communication interface 51 adds the port number allocated to the receiving physical port to the frame, and outputs the frame to the uplink reception-side buffers 52a to 52z.

The uplink reception-side buffers 52a to 52z temporarily store a frame output from the communication interface 51 for adjusting the processing speed and transfer speed between terminals. The frame stored in the buffer includes an SA for uniquely specifying a terminal and a port number indicating by which physical port the frame has been received.

The SA extracting unit 53 multiplexes data included in the uplink reception-side buffers 52a to 52z, extracts the port number and SA for each frame, and outputs the data including the extracted port number and SA to a network via the uplink transmission-side interface 54.

In the following explanations, the data including the port number and SA extracted from the uplink reception-side buffers 52a to 52z by the SA extracting unit 53 is referred to as “frame S” for descriptive purposes.

The uplink transmission-side interface 54 transfers the frame S input from the SA extracting unit 53 to a network (not depicted) connected to the communication relay device 50.

The learning-request queuing FIFO 55 temporarily stores the frame S so that the SA and port number included in the frame S are learned in the learning table 56, and includes a storage unit 55a and a processor 55b.

The storage unit 55a is a memory area for storing SAs in association with port numbers, and has a so-called “first-in first-out” data structure such that the stored SA and port number are extracted in order of storage. A specific data structure is explained with reference to FIG. 27.

FIG. 27 is a schematic diagram for explaining an example of the data structure of the storage unit of the learning-request queuing FIFO. The storage unit 55a depicted in FIG. 27 includes “memory number”, “port number”, and “source address”.

A source address “0A:11:34:3B:32” is stored in the port number “1”, a source address “21:2F:F1:12:30:0” is stored in the port number “2”, and a source address is not stored in a memory number 3, and thereafter indicating that two source addresses are sequentially learned in the learning table 56.

Returning to the explanation of FIG. 26, the processor 55b is explained below. The processor 55b causes the SA and port number stored in the storage unit 55a depicted in FIG. 27 to be learned in the learning table 56 according to a first-in first-out method.

In an example depicted in FIG. 27, the processor 55b causes the source address “0A:11:34:3B:32” to be learned in the learning table 56 first. After completion of learning, the processor 55b causes the source address “21:2F:F1:12:30:0” to be learned in the learning table 56.

When a source address is newly stored in the memory number 3, the processor 55b causes the source address stored in the memory number 3 to be learned in the learning table 56, after completion of learning of “21:2F:F1:12:30:0”.

The learning table 56 is a table in which source addresses stored in the storage unit 55a are learned in order of memory number, and input and output of data are controlled by the learning table controller 57. This configuration is specifically explained with reference to FIG. 28.

FIG. 28 is a schematic diagram for explaining a data structure of a learning table. The learning table 56 depicted in FIG. 28 includes “port numbers” and “source addresses”, and source addresses are stored in association with each of the port numbers. The “port numbers” and “source addresses” indicate the same information of the port numbers and the source addresses explained with reference to FIG. 27.

For example, the port number “4” and “00:11:22:33:44:5” are stored in association with each other, and the port number “3” and “10:20:30:40:50:6” are stored in association with each other.

Returning to the explanation of FIG. 26, the learning table controller 57 is explained below. The learning table controller 57 determines whether data having the same combination with a combination of the port number and SA included in the acquired frame S is stored in the learning table 56, and performs a learning process of the SA and port number according to a determination result.

Specifically, the learning table controller 57 determines whether the data included in the frame S matches any of data stored in the learning table 56. When the data in the frame S matches any of data in the learning table 56, the learning table controller 57 determines that learning has been performed already, and does not write the SA and port number included in the frame S in the learning-request queuing FIFO 55.

On the other hand, when the data in the frame S does not match any of data in the learning table 56, the learning table controller 57 writes the SA and port number included in the frame S in the learning-request queuing FIFO 55.

A process performed by the learning table controller 57 is specifically explained with reference to FIG. 29. FIG. 29 is a schematic diagram for explaining the process performed by the learning table controller 57. A frame 1 and a frame 2 are exemplified as the frame S for the following explanations.

The frame 1 has the port number “6” and an SA “1A:E1:62:54:19”, and the frame 2 has the port number “2” and an SA “2A:41:3F:33:A4:C5”.

The SA extracting unit 53 outputs the frame 1 and the frame 2 to the learning table controller 57 (Step S1), and then the learning table controller 57 searches the learning table 56 for data matching a combination of the port number and SA included in the frames 1 and 2 (Step S2).

In this case, the learning table controller 57 searches the learning table 56 for data matching the frame 2, determines that it is a source address already learned, and does not perform a learning process with respect to the frame 2.

On the other hand, at Step S2, because there is no data matching data of the frame 1 in the learning table 56, the learning table controller 57 determines that the SA included in the frame 1 is a source address, which has not been learned, and writes the data included in the frame 1 in a memory address “3” in the storage unit 55a (Step S3).

Subsequently, after data stored in memory numbers 1 and 2 are learned in the learning table 56 in order of memory number, the processor 55b causes the data stored in the memory number 3 to be learned in the learning table 56.

In this manner, when the data having a combination of the port number and SA same as that of the frame S input from the SA extracting unit 53 is not stored in the learning table 56, the learning table controller 57 causes the port number and SA included in the frame S to be learned in the learning table 56.

Returning to the explanation of FIG. 26, the downlink reception-side interface 58 is explained next. The downlink reception-side interface 58 receives a frame transmitted to a terminal.

The DA extracting unit 59 extracts a destination address (DA) from the frame received by the downlink reception-side interface 58 for each frame, and outputs the extracted DA to the destination searching unit 60.

The data including the DA extracted by the DA extracting unit 59 is referred to as “frame D” for descriptive purposes.

The destination searching unit 60 searches the learning table 56 whether data matching the DA included in the frame D is stored in the learning table 56, and when data matching therewith is found, the destination searching unit 60 outputs the port number to the output-destination port controller 61.

On the other hand, when data matching the DA included in the frame D is not stored in the learning table 56 and search is not successful, the destination searching unit 60 outputs a flag indicating that the DA has not been learned yet to the output-destination port controller 61.

The output-destination port controller 61 determines an output destination port based on the data input from the destination searching unit 60 and allocates the port. Specifically, when an SA and port number matching the data in the frame D received from the destination searching unit 60 have been learned, the output-destination port controller 61 outputs the frame to a predetermined physical port.

For example, when an SA matching the DA is present in the learning table 56 and the port number corresponds to the physical port 51a, the output-destination port controller 61 outputs the frame including the DA to the physical port 51a.

On the other hand, when a frame addressed to a terminal whose SA has not been learned yet (hereinafter, “unlearned terminal”) is received, the output-destination port controller 61 transfers the received frame to all ports excluding a reception port. For example, when the physical port 51b is used as the reception port, the output-destination port controller 61 outputs the frame including the DA addressed to the unlearned terminal to all ports excluding the physical port 51b.

In the following explanations, a process in which the communication relay device cannot allocate the output destination port and transfers a frame addressed to an unlearned terminal to all ports excluding the reception port is referred to as “flooding”.

The flooding occurs continuously until data matching a DA included in a frame addressed to an unlearned terminal is learned in the learning table 56. A DA₁ is explained below as an example of the address of the unlearned terminal.

In this case, when a frame including the DA₁ is received before an SA matching DA₁ is learned in the learning table 56, the output-destination port controller 61 continuously outputs the received frame to all ports excluding a port having received the frame.

The downlink transmission-side buffers 62a to 62z temporarily store frames transmitted to terminals, for adjusting the processing speed and transfer speed between terminals.

As a technique related to flooding, there has been known a technique such that when a frame in which a source media access control (MAC) address has not been learned yet but a destination MAC address has been learned is received, a communication relay device returns a virtual response frame emulating a response frame corresponding to a destination terminal to a source terminal (see, for example, Japanese Laid-open Patent Publication No. 2006-279820).

Furthermore, as an example of controlling a learning table, there has been disclosed a technique in which, when a threshold as a maximum number of terminals to be connected is exceeded, discarding of an address is performed as needed, to reduce a memory capacity required for the learning table, thereby reducing a processing load of the communication relay device (see, for example, Japanese Laid-open Patent Publication No. 2004-134973).

In the techniques described above, however, when there is flooding in a communication relay device, an excessive amount of frames is transferred to all ports other than a reception port. As a result, extra traffic increases, and thus the band is put under pressure.

The DA₁ mentioned above is exemplified for explanation. In this case, before an SA corresponding to the DA₁ (hereinafter, SA₁) is learned in the learning table 56, if there is another SA already stored in the storage unit 55a, the SA₁ is not learned in the learning table 56 until the other SA has been stored in the learning table 56.

Therefore, when flooding occurs such that a large amount of frames including the DA₁ addressed to a terminal are transmitted while the SA₁ is learned in the learning table 56, an excessive amount of frames is transferred to all ports other than the reception port, thereby increasing extra traffic and thus the band is put under pressure.

### SUMMARY

According to an aspect of an embodiment of the invention, a frame relay device includes a plurality of ports for receiving frames; a learning table in which source addresses of the received frames to be transmitted to a network are registered in association with the ports; an output-destination allocating unit that allocates a frame received from the network to a destination port by referring to the learning table; a storage unit that searches the learning table whether a destination address of a frame received from a network is registered in the learning table, and stores therein an unregistered one of the destination address; and a priority control unit that determines whether a source address of a frame received from the port is stored in the storage unit, and registers a source address stored in the storage unit in the learning table more preferentially than a source address not stored in the storage unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram for explaining an outline of a communication relay device according to a first embodiment of the present invention;

FIG. 2 is a schematic diagram for explaining the communication relay device according to the first embodiment;

FIG. 3 is a schematic diagram for explaining an example of a data structure of a learning table according to the first embodiment;

FIG. 4 is a schematic diagram for explaining an example of a data structure of a flooding-destination-address storage memory according to the first embodiment;

FIG. 5 is a schematic diagram for explaining an example of a data structure of a storage unit according to the first embodiment;

FIG. 6 is a schematic diagram for explaining an example of a data structure of a preferential-learning-SA storage memory according to the first embodiment;

FIG. 7 is a flowchart of a process performed by a flooding-destination-address informing unit according to the first embodiment;

FIG. 8 is a flowchart of a process performed by a match determining unit according to the first embodiment;

FIG. 9 is a flowchart of a process performed by a priority controller according to the first embodiment;

FIG. 10 is a schematic diagram for explaining a communication relay device according to a second embodiment of the present invention;

FIG. 11 is a schematic diagram for explaining an example of a data structure of a DA storage unit according to the second embodiment;

FIG. 12 is a schematic diagram for explaining a process performed by a DA controller according to the second embodiment;

FIG. 13 is a flowchart of a process performed by a flooding-destination-address informing unit according to the second embodiment;

FIG. 14 is a schematic diagram for explaining a communication relay device according to a third embodiment of the present invention;

FIG. 15 is a schematic diagram for explaining an example of a data structure when a preferential-learning-SA storage memory according to the third embodiment is formed of a FIFO;

FIG. 16 is a schematic diagram for explaining an example of a data structure when the preferential-learning-SA storage memory according to the third embodiment is formed of a RAM;

FIG. 17 is a flowchart of a process performed by a flooding-destination-address informing unit according to the third embodiment;

FIG. 18 is a flowchart of a process performed by a match determining unit when the preferential-learning-SA storage memory is formed of a FIFO;

FIG. 19 is a flowchart of a process performed by a priority controller when the preferential-learning-SA storage memory is formed of a RAM;

FIG. 20 is a schematic diagram for explaining an input rate;

FIG. 21 is a schematic diagram for explaining an output rate to a port 1 in a conventional technique;

FIG. 22 is a schematic diagram for explaining a precondition for explaining effects of the present invention;

FIG. 23 is a schematic diagram for explaining effects of embodiments;

FIG. 24 is a schematic diagram for explaining discarding of a frame;

FIG. 25 is a schematic diagram for explaining discarding of a learning request;

FIG. 26 is a schematic diagram for explaining a conventional communication relay device;

FIG. 27 is a schematic diagram for explaining an example of a data structure of a storage unit included in a learning-request queuing FIFO;

FIG. 28 is a schematic diagram for explaining a data structure of a learning table; and

FIG. 29 is a schematic diagram for explaining a process performed by a learning table controller.

### DESCRIPTION OF EMBODIMENTS

Preferred embodiments of the present invention will be explained with reference to accompanying drawings. The present invention is not limited thereto. The frame relay device is explained below simply as “communication relay device”.

### [a] First Embodiment

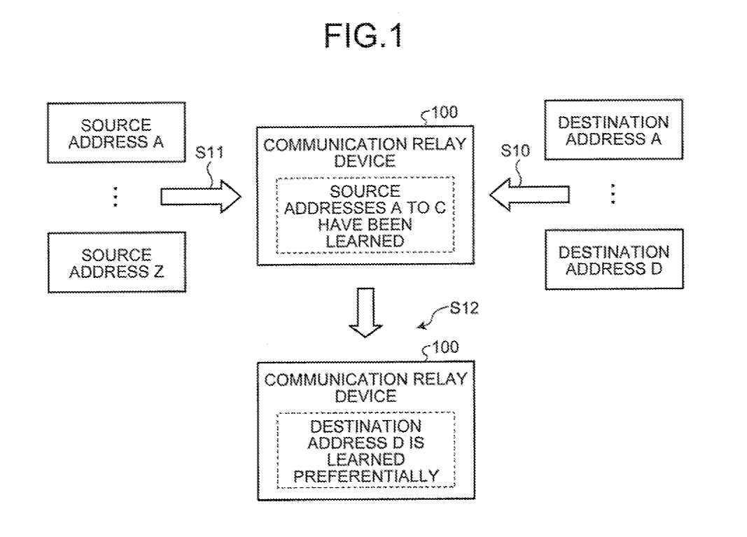

An outline of a communication relay device according to a first embodiment of the present invention is explained first. FIG. 1 is a schematic diagram for explaining the outline of the communication relay device according to the first embodiment. A communication relay device 100 depicted in FIG. 1 includes a memory that stores a destination address causing flooding in advance, separately from a learning table.

When a source address is to be learned, if the source address matches the stored destination address in advance, the matching source address and port number are learned more preferentially than other source addresses.

Specifically, a case that source addresses A to C have been already learned in the learning table included in the communication relay device 100 is explained as an example. In this case, the communication relay device 100 receives a frame having destination addresses A to D (Step S10).

In this case, because the source addresses A to C matching the destination addresses A to C have been already learned, the frames are respectively transmitted to ports having predetermined port numbers without the source addresses A to C being learned again. On the other hand, because the address D has not been learned yet, the address D is temporarily stored in a priority memory as an address causing flooding.

Thereafter, upon reception of a frame from terminals having source addresses A to Z (Step S11), the communication relay device 100 does not perform a learning process for the source addresses A to C because these addresses have been learned.

On the other hand, because a destination address matching the source address D and port number thereof are held in the priority memory, the communication relay device 100 causes the source address D to be learned in the learning table more preferentially than other source addresses E to Z (Step S12).

At Step S12, the communication relay device 100 writes the other source addresses E to Z in the learning-request queuing FIFO. As a result, after the SA written in the learning-request queuing FIFO has been learned in the learning table, the source addresses E to Z are sequentially learned in the learning table.

In this manner, upon reception of a frame from a terminal having a destination address causing flooding, the communication relay device 100 according to the first embodiment can suppress flooding by causing the source address and port number matching the destination address to be learned preferentially.

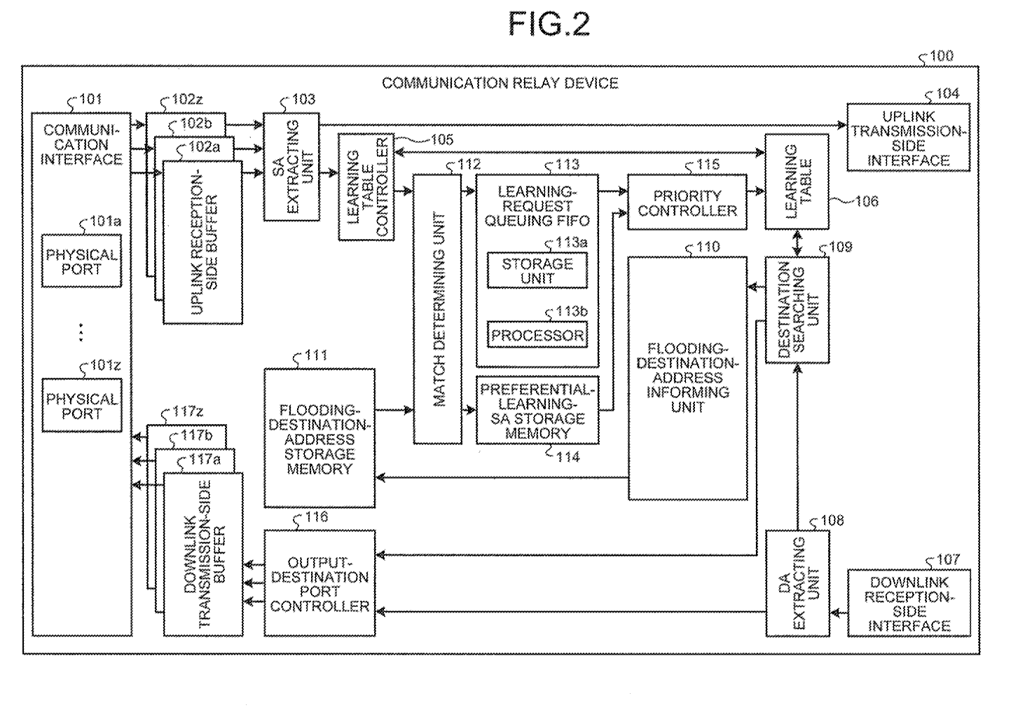

Specific functions of the communication relay device 100 are explained next with reference to FIG. 2. FIG. 2 is a schematic diagram for explaining the communication relay device according to the first embodiment.

The communication relay device 100 depicted in FIG. 2 performs a transferring process of a frame between terminals, and includes a communication interface 101, uplink reception-side buffers 102a to 102z, a source address (SA) extracting unit 103, an uplink transmission-side interface 104, a learning table controller 105, a learning table 106, a downlink reception-side interface 107, a DA extracting unit 108, a destination searching unit 109, a flooding-destination-address informing unit 110, a flooding-destination-address storage memory 111, a match determining unit 112, a learning-request queuing FIFO 113, a preferential-learning-SA storage memory 114, a priority controller 115, an output-destination port controller 116, and downlink transmission-side buffers 117a to 117z.

The communication interface 101 transmits and receives a frame to and from a terminal group connected to the communication relay device 100, and includes physical ports 101a to 101z.

The physical ports 101a to 101z indicate ports physically provided in the communication relay device 100.

A number is respectively allocated to each port. For example, each port has a specific number in the communication relay device 100, such that 1 is allocated to the physical port 101a, 2 is allocated to physical port 101b and onwards, 25 is allocated to the physical port 101y, and 26 is allocated to the physical port 101z.

Upon reception of a frame from a terminal, the communication interface 101 adds the port number to the received frame, and outputs the frame to the uplink reception-side buffers 102a to 102z.

The uplink reception-side buffers 102a to 102z temporarily store a frame output from the communication interface 101 for adjusting the processing speed and transfer speed between terminals.

The frame stored in the buffer includes a source address (SA) for uniquely specifying a terminal and a port number.

The uplink reception-side buffers 102a to 102z include information to be allocated to each physical port. For example, the uplink reception-side buffer 102a is allocated to the physical port 101a, and the uplink reception-side buffer 102b is allocated to the physical port 101b.

The SA extracting unit 103 multiplexes data included in the uplink reception-side buffers 102a to 102z, extracts the port number allocated to the received port and the SA for each frame, and outputs the data including the extracted port number and SA to a network via the uplink transmission-side interface 104.

In the following explanations, the data including the port number and SA extracted from the uplink reception-side buffers 102a to 102z by the SA extracting unit 103 is referred to as “frame S1” for descriptive purposes.

The uplink transmission-side interface 104 transfers the frame S1 input from the SA extracting unit 103 to the network connected to the communication relay device 100.

The learning table controller 105 determines whether the data indicated by the frame S1 is stored in the learning table 106, and performs a learning process of the SA and port number included in the frame S1 based on a determination result.

Specifically, the learning table controller 105 determines whether data included in the frame S1 matches any of data stored in the learning table 106, and when the data in the frame S1 matches the data in the learning table 106, the learning table controller 105 does not output the frame S1 to the match determining unit 112, as already learned data.

On the other hand, when data matching data stored in the learning table 106 is not included in the frame S1, the learning table controller 105 outputs the frame S1 to the match determining unit 112.

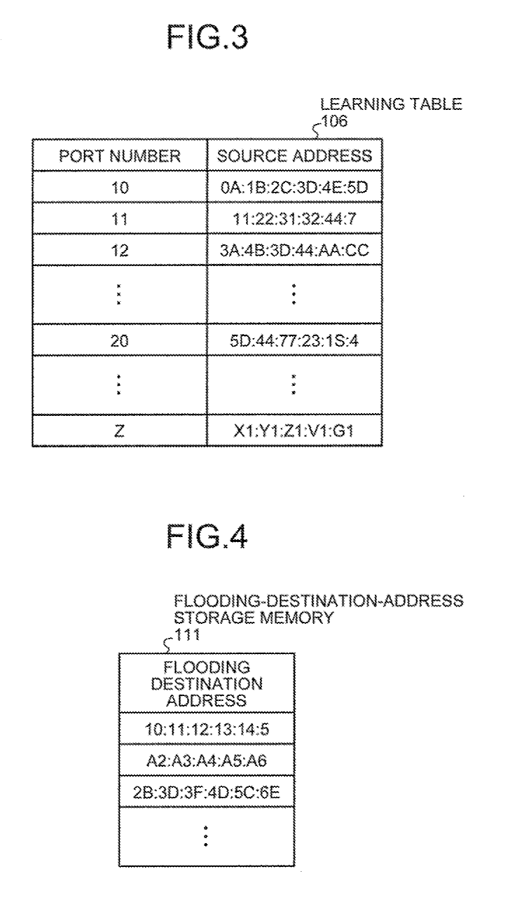

The SA and the port number are stored in the learning table 106 by the learning process performed by the learning-request queuing FIFO 113 and the priority controller 115. A specific data structure is explained with reference to FIG. 3.

FIG. 3 is a schematic diagram for explaining an example of a data structure of the learning table according to the first embodiment. The learning table 106 depicted in FIG. 3 includes “port number” and “source address”, and the source address is stored in association with each port number.

The “port number” indicates a port that has received the frame, and is information added to the frame received by the communication interface 101. A port number 10 corresponds to the physical port 101a, and a port number 11 corresponds to the physical port 101b.

The “source address” indicates a specific address provided to a terminal. For example, when a source address “0A:1B:2C:3D:4E:5D” is provided to a transmission terminal, the communication relay device 100 identifies the transmission terminal from the source address in the received frame, and performs a transferring process of the frame.

Returning to the explanation of FIG. 2, the downlink reception-side interface 107 is explained next. The downlink reception-side interface 107 receives a frame transmitted to a terminal.

The DA extracting unit 108 extracts the destination address (DA) from the frame received by the downlink reception-side interface 107 for each frame, and outputs the extracted DA to the destination searching unit 109. The DA extracting unit 108 also outputs the frame to the output-destination port controller 116.

The data including the DA extracted by the DA extracting unit 108 is referred to as “frame D1” for descriptive purposes.

The destination searching unit 109 searches the learning table 106 whether the data matching the frame D1 is stored in the learning table 106, and when matching data is found, outputs a port number corresponding to the DA to the output-destination port controller 116.

On the other hand, when data matching the frame D1 is not stored in the learning table 106, and matching data cannot be found, the destination searching unit 109 outputs the DA to the flooding-destination-address informing unit 110 as an address of an unlearned terminal. Further, when data matching the frame D1 is not stored in the learning table 106, and matching data cannot be found, the destination searching unit 109 outputs a flag indicating that the data is not registered in the learning table to the output-destination port controller 116.

Among the frames addressed to a terminal received by the downlink reception-side interface 107, a frame including a DA that does not match the SA stored in the learning table 106 is referred to as “frame addressed to an unlearned terminal”, and the DA included in the frame addressed to the unlearned terminal is referred to as “flooding destination address”.

The flooding-destination-address informing unit 110 monitors a destination address causing flooding, and when a frame addressed to an unlearned terminal is input from the destination searching unit 109, outputs the DA included in the input frame to the flooding-destination-address storage memory 111.

For example, when a frame addressed to an unlearned terminal is input from the destination searching unit 109 and a DA:“10:11:12:13:14:5” is included in the input frame, the flooding-destination-address informing unit 110 outputs the input frame to the flooding-destination-address storage memory 111.

The flooding-destination-address storage memory 111 stores the flooding destination address input from the flooding-destination-address informing unit 110. The specific data structure is explained with reference to FIG. 4.

FIG. 4 is a schematic diagram for explaining an example of a data structure of the flooding-destination-address storage memory. The flooding-destination-address storage memory 111 depicted in FIG. 4 includes “flooding destination address”.

As examples of the flooding destination addresses, “10:11:12:13:14:5”, “A2:A3:A4:A5:A6”, and “2B:3D:3F:4D:5C:6E” are stored.

Returning to the explanation of FIG. 2, the match determining unit 112 is explained. When the SA indicated by the frame S1 matches the flooding destination address indicated by the frame D1, the match determining unit 112 outputs the matching SA and port number to the preferential-learning-SA storage memory 114.

On the other hand, when the SA indicated by the frame S1 does not match the flooding destination address indicated by the frame D1, the match determining unit 112 outputs the SA and port number included in the frame S1 to the learning-request queuing FIFO 113.

The learning-request queuing FIFO 113 temporarily stores the SA and the port number before being stored in the learning table 106, so that the stored SA and port number are learned in the learning table 106, and includes a storage unit 113a and a processor 113b.

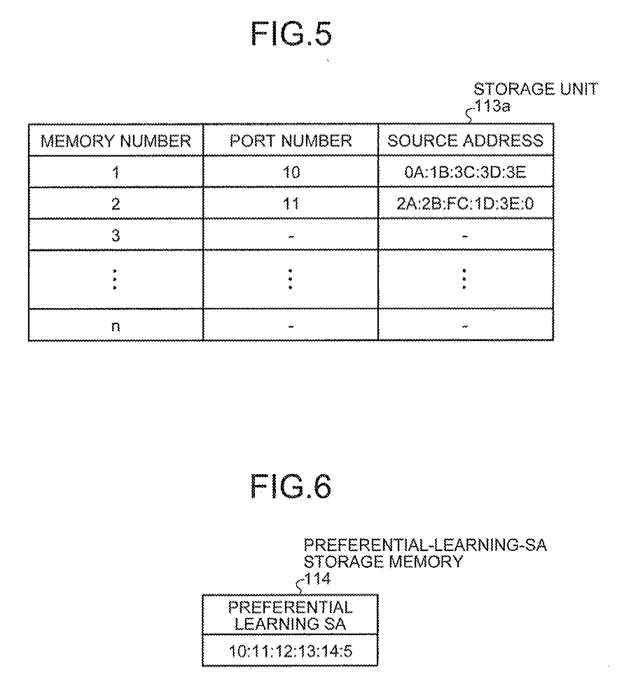

The storage unit 113a is a storage area for storing the SA in association with each port number, and has a so-called “first-in first-out” data structure such that the stored SA is extracted in order of storage. A specific data structure is explained with reference to FIG. 5.

FIG. 5 is a schematic diagram for explaining an example of the data structure of the storage unit according to the first embodiment. The storage unit 113a depicted in FIG. 5 includes “memory number”, “port number”, and “source address”.

The “memory number” indicates an order that the source address stored in the storage unit 113a is learned in the learning table 106, and a memory capacity of the storage unit 113a is proportional to a value of a memory number “n”.

The “port number” corresponds to the physical port depicted in FIG. 2. For example, the port number “10” corresponds to the physical port 101a, the port number “11” corresponds to the physical port 101b, and the port number “n” corresponds to the physical port 101z.

The source address indicates the SA stored by the processor 113b. The source address indicates data in which data having the same combination as that of the destination address and port number included in the frame S1 is not stored in the learning table 106.

Subsequently, returning to the explanation of FIG. 2, the processor 113b is explained next. The processor 113b causes the source address stored in the storage unit 113a depicted in FIG. 2 to be learned in the learning table 106 according to a “first-in first-out” principle.

In an example depicted in FIG. 5, a processor 114b causes a source address “0A:1B:3C:3D:3E” to be learned in the learning table 106 first. After completion of learning, the processor 114b causes a source address “2A:2B:FC: 1D:3E:0” to be learned in the learning table 106.

When a source address is newly stored in the memory number 3, the processor 113b causes the source address stored in the memory number 3 to be learned in the learning table 106, after completion of learning of “2A:2B:FC: 1D:3E:0”.

Returning to the explanation of FIG. 2, the preferential-learning-SA storage memory 114 is explained next. The preferential-learning-SA storage memory 114 stores the flooding destination address output from the match determining unit 112.

The SA matching the flooding destination address is learned in the learning table 106 more preferentially than the SA stored in the storage unit 113a by a process performed by the priority controller 115.

A specific data structure of the preferential-learning-SA storage memory 114 is explained with reference to FIG. 6. FIG. 6 is a schematic diagram for explaining an example of the data structure of the preferential-learning-SA storage memory according to the first embodiment.

“Preferential learning SA” is stored in the preferential-learning-SA storage memory 114 depicted in FIG. 6.

The “preferential learning SA” indicates an SA input by the match determining unit 112. As an example, “10:11:12:13:14:5” is stored.

A process performed by the match determining unit 112 depicted in FIG. 2 by exemplifying the preferential-learning-SA storage memory 114 is explained with reference to FIGS. 2 to 6. A case that the SA extracting unit 103 extracts “10:11:12:13:14:5”, “0A:1B:3C:3D:3E”, and “2A:2B:FC:1D:3E:0” is explained as an example.

The match determining unit 112 first acquires the SA and port number input by the learning table controller 105, and then acquires the flooding destination address stored in the flooding-destination-address storage memory 111.

The match determining unit 112 compares the flooding destination address stored in the flooding-destination-address storage memory 111 depicted in FIG. 4 with the SA acquired from the SA extracting unit 103, to search for matching data.

Because the flooding destination address “10:11:12:13:14:5” is stored in the flooding-destination-address storage memory 111 depicted in FIG. 4, the match determining unit 112 outputs the matching SA to the preferential-learning-SA storage memory 114 together with the port number.

On the other hand, as for “0A:1B:3C:3D:3E” and “2A:2B:FC:1D:3E”, matching data cannot be found in the flooding-destination-address storage memory 111, the match determining unit 112 outputs the SA to the learning-request queuing FIFO 113 together with the corresponding port information.

Accordingly, as depicted in FIG. 5, “0A:1B:3C:3D:3E” and “2A:2B:FC:1D:3E:0” are stored in the memory number 1 and the memory number 2 of the storage unit 113a.

On the other hand, “10:11:12:13:14:5” is stored in the preferential-learning-SA storage memory 114 depicted in FIG. 6 together with the corresponding port number, and is learned in the learning table 106 more preferentially than the data stored in the storage unit 113a.

Returning to the explanation of FIG. 2, the priority controller 115 is explained next. When the preferential learning SA is stored in the preferential-learning-SA storage memory 114, the priority controller 115 causes the preferential learning SA stored in the preferential-learning-SA storage memory 114 to be learned in the learning table 106 more preferentially than the source address stored in the storage unit 113a.

For example, as depicted in FIG. 5, “0A:1B:3C:3D:3E” and “2A:2B:FC:1D:3E:0” are stored as the source address in the storage unit 113a, and “10:11:12:13:14:5” is stored in the preferential-learning-SA storage memory 114 depicted in FIG. 6.

In this case, the priority controller 115 causes “10:11:12:13:14:5” to be learned in the learning table 106 more preferentially than “0A:1B:3C:3D:3E” and “2A:2B:FC:1D:3E:0”.

On the other hand, when a preferential learning SA is not stored in the preferential-learning-SA storage memory 114, the processor 113b causes “0A:1B:3C:3D:3E” and “2A:2B:FC:1D:3E:0” to be learned in the learning table 106 sequentially.

The output-destination port controller 116 determines an output destination port based on the frame input from the destination searching unit 109, and allocates the port. Specifically, the output-destination port controller 116 receives a frame including a port number corresponding to the DA input from the destination searching unit 109, and outputs the frame to the port corresponding to the port number.

For example, when there is an SA matching the DA in the learning table 106 and the port number of the DA corresponds to the physical port 101a, the output-destination port controller 116 outputs the frame including the DA to a physical port 301a.

On the other hand, when a frame addressed to an unlearned terminal is received, the output-destination port controller 116 transfers the received frame to all ports excluding a reception port. For example, when the physical port 101b is used as the reception port, the output-destination port controller 61 outputs the frame including the DA of the unlearned terminal to all ports excluding the physical port 101b.

The downlink transmission-side buffers 117a to 117z temporarily store a frame to be transmitted to a terminal for adjusting the processing speed and transfer speed between the terminals.

According to the communication relay device of the first embodiment, upon reception of a frame from a terminal having a destination address that causes flooding, the priority controller 115 causes the destination address to be learned in the learning table 106 preferentially, thereby enabling to suppress flooding.

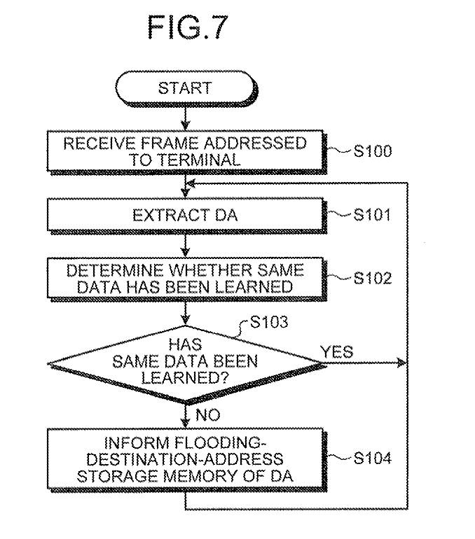

A process procedure performed by the flooding-destination-address informing unit 110 is explained next. FIG. 7 is a flowchart of a process performed by the flooding-destination-address informing unit according to the first embodiment.

After the downlink reception-side interface 107 receives a frame addressed to a terminal (Step S100), the DA extracting unit 108 first extracts a DA from the frame addressed to the terminal received at Step S100 (Step S101).

The destination searching unit 109 searches the learning table 106 whether data same as the data extracted at Step S101 has been learned in the learning table 106 (Step S102). When the same data has been learned (YES at Step S103), control proceeds to Step S100.

On the other hand, when the same data has not been learned (NO at Step S103), the destination searching unit 109 informs the flooding-destination-address informing unit 110 of the DA included in the data extracted at Step S101.

The flooding-destination-address informing unit 110 outputs the informed DA to the flooding-destination-address storage memory 111 (Step S104).

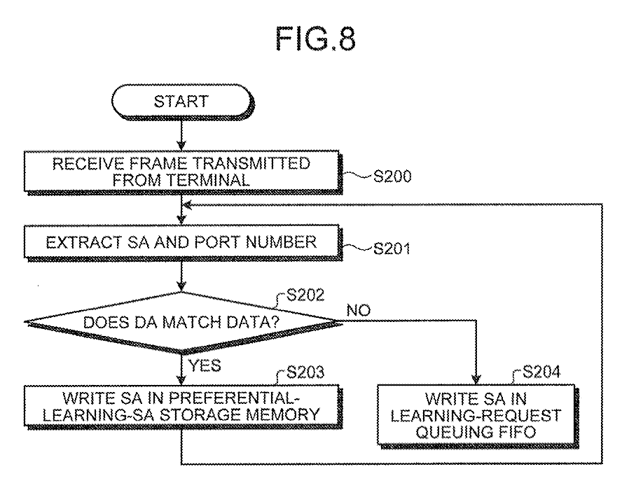

A process procedure performed by the match determining unit 112 is explained next. FIG. 8 is a flowchart of a process performed by the match determining unit according to the first embodiment.

The communication interface 101 first receives a frame transmitted from a terminal (Step S200). The SA extracting unit 103 extracts an SA and port number from the frame received at Step S200 (Step S201).

The match determining unit 112 determines whether a DA stored in the flooding-destination-address storage memory 111 matches the data extracted at Step S201. When the DA matches the data (YES at Step S202), the match determining unit 112 writes the matching SA in the preferential-learning-SA storage memory 114 (Step S203).

On the other hand, when the DA does not match the data (NO at Step S202), the match determining unit 112 writes the SA extracted at Step S201 in the learning-request queuing FIFO 113 (Step S204). The processor 113b causes the SA extracted at Step S201 to be learned in the learning table 106, after other SAs stored in the storage unit 113a are learned.

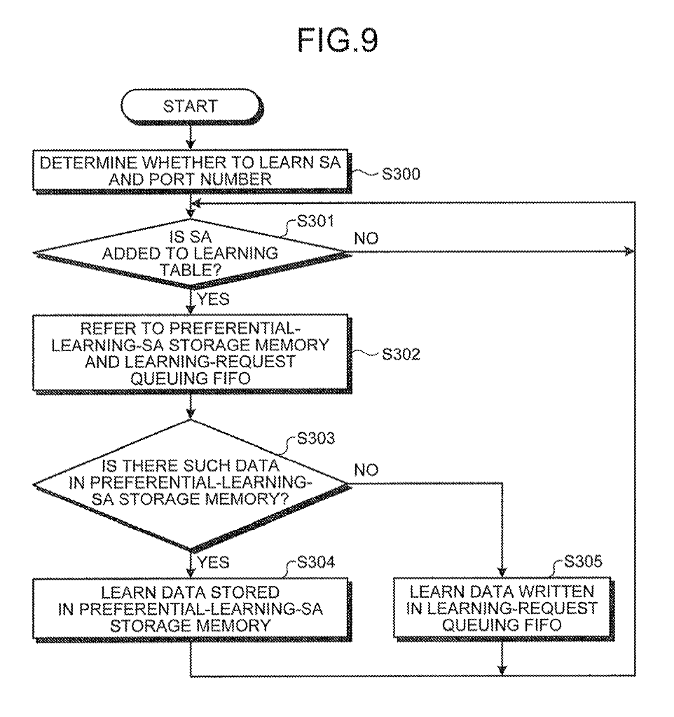

A process procedure performed by the priority controller 115 is explained next. FIG. 9 is a flowchart of a process performed by the priority controller according to the first embodiment.

The priority controller 115 first determines whether the SA and the port number can be learned in the learning table 106 based on a memory capacity of the learning table 106 (Step S300).

When a new SA is to be learned in the learning table 106 (YES at Step S301), the priority controller 115 refers to the learning-request queuing FIFO 113 and the preferential-learning-SA storage memory 114 (Step S302).

The priority controller 115 determines whether data as a target of a learning request is stored in the preferential-learning-SA storage memory 114. When there is such data (YES at Step S303), the priority controller 115 causes the data stored in the preferential-learning-SA storage memory 114 to be learned preferentially in the learning table 106 than the data stored in the learning-request queuing FIFO 113 (Step S304).

On the other hand, when there is no such data in the preferential-learning-SA storage memory 114 (NO at Step S303), the processor 113b causes the SA stored in the storage unit 113a to be learned in the learning table 106 (Step S305).

According to the flowchart, because the flooding destination address is stored in the preferential-learning-SA storage memory 114, separately from the learning-request queuing FIFO 113, the stored flooding destination address can be learned preferentially, thereby enabling to suppress a frequency of generations of flooding.

### [b] Second Embodiment

The communication relay device 100 according to the first embodiment learns the preferential learning SA stored in the preferential-learning-SA storage memory 114 preferentially, regardless of use frequency of a band.

For example, it is assumed that the communication relay device 100 performs a transferring process of a frame to a terminal a hundred times within a certain predetermined time, whereas the communication relay device 100 performs a transferring process of a frame to the terminal 101 only once.

In this case, it is more effective for suppressing the frequency of generations of flooding to preferentially learn a DA held by the terminal 100 than to learn a DA held by the terminal 101.

A communication relay device 200 according to a second embodiment of the present invention determines a flooding destination address to be learned preferentially, based on a frequency of extractions of the flooding destination address, and learns the flooding destination address based on a determination result.

The communication relay device 200 has substantially the same functions as those of the communication relay device 100 depicted in FIG. 2. A different point from the communication relay device 100 is that only a DA satisfying a predetermined condition is output and stored in a preferential-learning-SA storage memory 214, when a DA included in the extracted frame addressed to an unlearned terminal is output to a flooding-destination-address storage memory 211.

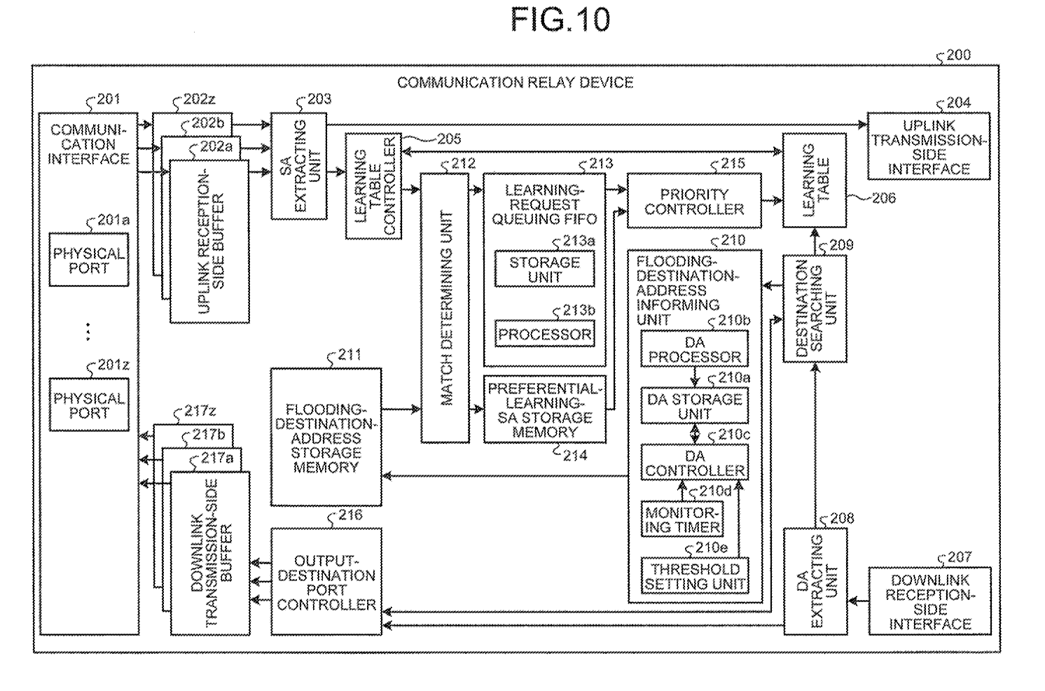

The communication relay device 200 is explained in detail with reference to FIG. 10. FIG. 10 is a schematic diagram for explaining the communication relay device according to the second embodiment. Detailed explanations of functional parts having the same functions as those of the communication relay device 100 according to the first embodiment will be omitted.

A communication interface 201 corresponds to the communication interface 101 depicted in FIG. 1, and for example, transmits and receives a frame to and from a terminal group connected to the communication relay device 200.

The communication interface 201 has physical ports 201a to 201z, and the physical ports indicate ports physically provided in the communication relay device 200.

A port number is respectively allocated to each port that receives a frame as in the first embodiment.

Uplink reception-side buffers 202a to 202z correspond to the uplink reception-side buffers 102a to 102z depicted in FIG. 2, and temporarily store a frame received from a terminal for adjusting the processing speed and transfer speed between terminals.

A source address (SA) held by a terminal and port number corresponding to the SA are included in a frame stored in the uplink reception-side buffers 202a to 202z.

An SA extracting unit 203 corresponds to the SA extracting unit 103 depicted in FIG. 2, and extracts the port number and the SA from the buffers for each frame and outputs the extracted frame including the port number and SA to the network via an uplink transmission-side interface 204.

In the following explanations, data including the port number and SA extracted from the uplink reception-side buffers 202a to 202z by the SA extracting unit 203 is referred to as “frame S2” for descriptive purposes.

The uplink transmission-side interface 204 transfers the frame S2 input from the SA extracting unit 203 to the network connected to the communication relay device 200.

A learning table controller 205 corresponds to the learning table controller 105 depicted in FIG. 2, determines whether data indicated by the frame S2 is stored in a learning table 206, and performs a learning process of the SA and port number included in the frame S2 according to a determination result.

Specifically, the learning table controller 205 determines whether the data indicated by the frame S2 matches any of data stored in the learning table 206. When the data matches any of data in the learning table 206, the learning table controller 205 determines that learning has been performed already, and does not output the frame S2 to a match determining unit 212.

On the other hand, when data matching data stored in the learning table 206 is not included in the frame S2, the learning table controller 205 outputs the frame S2 to the match determining unit 212.

The learning table 206 corresponds to the learning table 106 depicted in FIG. 2, and as depicted in FIG. 3, includes “port number” and “source address”, and a source address is stored in association with each port number.

A downlink reception-side interface 207 corresponds to the downlink reception-side interface 107 depicted in FIG. 2, and receives a frame to be transmitted to a terminal.

A DA extracting unit 208 corresponds to the DA extracting unit 108 depicted in FIG. 2, extracts a destination address (DA) from the frame transmitted to a terminal for each frame, and outputs the extracted DA to a destination searching unit 209. The DA extracting unit 208 outputs the frame from the downlink reception-side interface 207 to an output-destination port controller 216.

The data including the DA extracted by the DA extracting unit 208 is referred to as “frame D2” for descriptive purposes.

The destination searching unit 209 corresponds to the destination searching unit 109 depicted in FIG. 2, and searches the learning table 206 whether data matching the data included in the frame D2 is stored in the learning table 206.

As a result of search, when data matching therewith is found, the destination searching unit 209 outputs the port number to the output-destination port controller 216.

On the other hand, when data matching the data included in the frame D2 is not stored in the learning table 206 and search is not successful, the destination searching unit 209 outputs the data including the frame D2 to a flooding-destination-address informing unit 210 as a frame addressed to an unlearned terminal.

A frame addressed to a terminal received by the downlink reception-side interface 207 and having a DA that does not match the SA stored in the learning table 206 is referred to as “frame addressed to an unlearned terminal”, and the DA included in the frame addressed to the unlearned terminal is referred to as “flooding destination address”.

The flooding-destination-address informing unit 210 determines a frequency of generations of a frame addressed to an unlearned terminal within a predetermined time, and outputs the flooding destination address to the flooding-destination-address storage memory 211 based on a determination result.

The flooding-destination-address informing unit 210 includes a DA storage unit 210a, a DA processor 210b, a DA controller 210c, a monitoring timer 210d, and a threshold setting unit 210e.

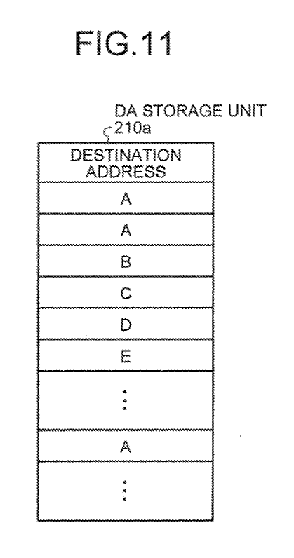

The DA storage unit 210a stores a frame addressed to an unlearned terminal output by the destination searching unit 209, and a specific data structure thereof is explained with reference to FIG. 11. FIG. 11 is a schematic diagram for explaining an example of the data structure of the DA storage unit according to the second embodiment.

“Destination address” is stored in the DA storage unit 210a depicted in FIG. 11. “Destination address” indicates an address in which an SA matching the DA included in the frame D2 has not been learned in the learning table 206.

For illustrative purposes, the destination addresses are designated as “A” and “B” as depicted in FIG. 11. However, as for an address corresponding to A, “AA:1B:CC:DD:4G:5Y” can be mentioned, and the same thing applies to B and others.

Returning to the explanation of FIG. 10, the DA processor 210b is explained. The DA processor 210b stores the DA input from the destination searching unit 209 in the DA storage unit 210a.

Specifically, the destination searching unit 209 searches the learning table 206 for the SA corresponding to the DA included in the frame D2 (For example, the address A), and when search is not successful, outputs the address A to the DA processor 210b.

The DA processor 210b stores the address A input from the destination searching unit 209 in the DA storage unit 210a. In this manner, the DA processor 210b sequentially stores the DA input from the destination searching unit 209 in the DA storage unit 210a.

The DA controller 210c determines the number of predetermined destination addresses stored in the DA storage unit 210a within a predetermined time, and informs the flooding-destination-address storage memory 211 of the determined destination addresses based on a determination result.

The monitoring timer 210d outputs time information to the DA controller 210c, and for example, outputs predetermined time information such as 5 seconds or 10 seconds. The time information indicates an effective time of the destination address as a determination target of the DA controller 210c.

For example, when the destination address A depicted in FIG. 11 is a determination target and the time information output by the monitoring timer 210d is 10 seconds, the DA controller 210c searches for the destination address A sequentially from the destination address stored at the top of the DA storage unit 210a for 10 seconds.

When 11 seconds has passed from the start of search, the DA controller 210c searches for a destination address different from the destination address A (for example, the destination address B) for 10 seconds.

In this manner, when the time information output by the monitoring timer 210d is exceeded, the DA controller 210c searches for a destination address different from the destination address as a search target. The time information output by the monitoring timer 210d is set by, for example, an administrator of the communication relay device 200.

The threshold setting unit 210e outputs threshold information for determining a frequency of generations of a frame addressed to an unlearned terminal to the DA controller 210c, and for example, threshold information such as “2” and “3” is output. The information output by the threshold setting unit 210e is set by, for example, the administrator of the communication relay device 200.

A process performed by the DA controller 210c is specifically explained by exemplifying the DA storage unit 210a, the DA processor 210b, the DA controller 210c, the monitoring timer 210d, and the threshold setting unit 210e.

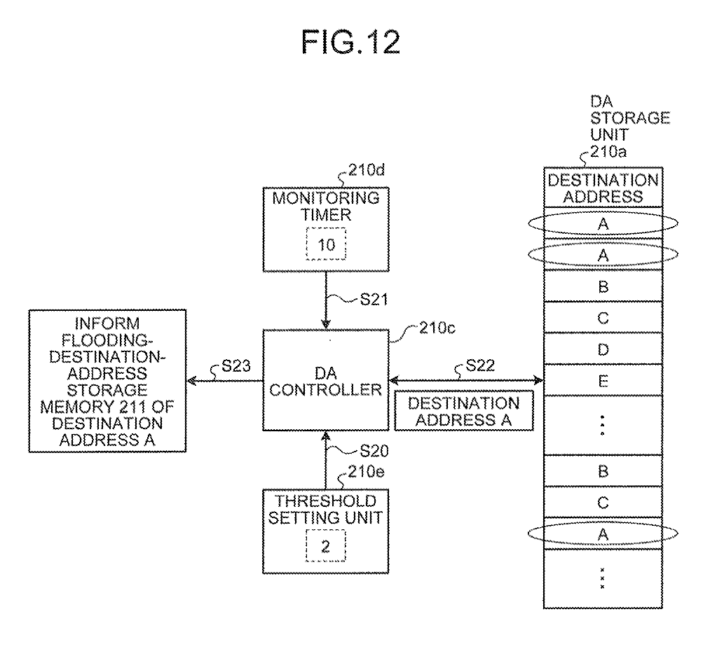

FIG. 12 is a schematic diagram for explaining the process performed by the DA controller according to the second embodiment. It is assumed for the following explanations that the time information set in the monitoring timer 210d is “10 seconds”, and the threshold information set in the threshold setting unit 210e is “2”.

The threshold setting unit 210e outputs threshold information “2” to the DA controller 210c (Step S20). The monitoring timer 210d outputs time information “10 seconds” to the DA controller 210c (Step S21).

The DA controller 210c determines the number of searches of the destination address A within 10 seconds, designating the destination address A stored at the top of the DA storage unit 210a as a search target. Under such a condition, when the destination address A is found three times within 10 seconds, the DA controller 210c acquires the destination address A from the DA storage unit 210a (Step S22).

The DA controller 210c then informs the flooding-destination-address storage memory 211 of the acquired destination address A (Step S23). Thereafter, the DA controller 210c starts searching for a destination address different from the destination address A.

At Step S22, when the number of searches of the destination address A detected by the DA controller 210c is 2 or less, the destination address A is not informed to the flooding-destination-address storage memory 211.

In the example depicted in FIG. 12, the destination address stored at the top of the DA storage unit 210a is set as a search target. However, the destination address as the search target can be arbitrarily set, and for example, the destination address B or C can be set as the search target.

Returning to the explanation of FIG. 10, the flooding-destination-address storage memory 211 is explained next. The flooding-destination-address storage memory 211 corresponds to the flooding-destination-address storage memory 111 depicted in FIG. 2, and includes “flooding destination address” and “port number” depicted in FIG. 4.

The “flooding destination address” indicates the destination address input from the DA controller 210c, and the destination addresses A and B depicted in FIG. 11 are stored as the flooding destination address.

The match determining unit 212 corresponds to the match determining unit 112 depicted in FIG. 2. When the data included in the frame S2 matches the flooding destination address stored in the flooding-destination-address storage memory 211, the match determining unit 212 outputs an SA corresponding to the flooding destination address to the preferential-learning-SA storage memory 214.

On the other hand, when the data included in the frame S1 does not match the flooding destination address stored in the flooding-destination-address storage memory 211, the match determining unit 212 outputs the data indicated by the frame S2 to a learning-request queuing FIFO 213.

The learning-request queuing FIFO 213 corresponds to the learning-request queuing FIFO 113 depicted in FIG. 2, and includes a storage unit 213a and a processor 213b, which correspond to the storage unit 113a and the processor 113b depicted in FIG. 2.

The storage unit 213a stores “memory number”, “port number”, and “source address” depicted in FIG. 5. The processor 213b causes the source address stored in the storage unit 213a to be learned in the learning table 206 according to the “first-in first-out” principle.

The preferential-learning-SA storage memory 214 corresponds to the preferential-learning-SA storage memory 114 depicted in FIG. 2, and includes “port number” and “preferential learning SA” depicted in FIG. 6. The flooding destination address output from the match determining unit 212 is stored therein.

When the preferential learning SA is stored in the preferential-learning-SA storage memory 214, a priority controller 215 causes the preferential learning SA in the preferential-learning-SA storage memory 214 to be learned in the learning table 206 more preferentially than the data stored in the storage unit 213a.

The output-destination port controller 216 corresponds to the output-destination port controller 116 depicted in FIG. 2, and determines an output destination port based on the frame input from the destination searching unit 209, and allocates the port.

Downlink transmission-side buffers 217a to 217z correspond to the downlink transmission-side buffers 117a to 117z depicted in FIG. 2, temporarily store a frame to be transmitted to a terminal for adjusting the processing speed and transfer speed between terminals, and have a frame including a DA addressed to the terminal and port number.

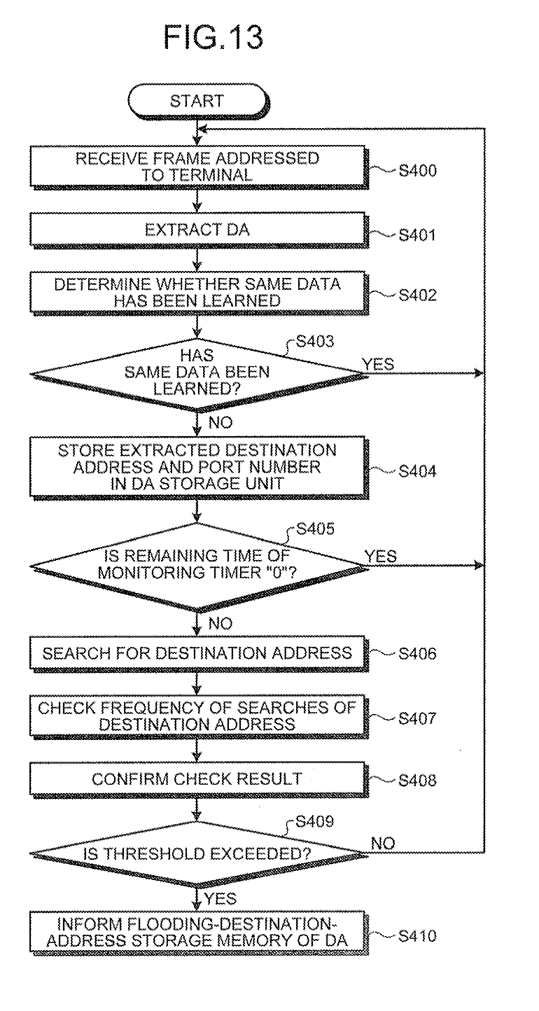

A process procedure performed by the flooding-destination-address informing unit 210 is explained next. FIG. 13 is a flowchart of a process performed by the flooding-destination-address informing unit according to the second embodiment.

After the downlink reception-side interface 207 receives a frame addressed to a terminal (Step S400), the DA extracting unit 208 first extracts a DA from the frame addressed to the terminal received at Step S400 (Step S401).

The destination searching unit 209 determines whether data same as the frame D2 extracted at Step S401 has been learned in the learning table 206 (Step S402).

When the data has been learned in the learning table 206 (YES at Step S402), control proceeds to Step S400.

On the other hand, when the data has not been learned in the learning table 206 (NO at Step S402), the destination searching unit 209 informs the DA processor 210b of the frame D2 extracted at Step S401. The DA processor 210b outputs the informed frame D2 to the DA storage unit 210a (Step S404).

When a remaining time in the time information input from the monitoring timer 210d is not “0” (NO at Step S405), the DA controller 210c starts searching for the DA stored at the top of the DA storage unit 210a (Step S406).

On the other hand, when the remaining time in the time information input from the monitoring timer 210d is “0” (YES at Step S405), control proceeds to Step S400.

The DA controller 210c confirms a frequency of searches of the DA at Step S406 (Step S407), and determines whether the frequency of searches of the DA exceeds the threshold information input from the threshold setting unit 210e (Step S408).

When having determined that the threshold is exceeded (YES at Step S409), the DA controller 210c outputs the DA determined at Step S408 to the flooding-destination-address storage memory 211 (Step S410).

On the other hand, when having determined that the threshold is not exceeded (NO at Step S409), the DA controller 210c does not output the DA determined at Step S408 to the flooding-destination-address storage memory 211. Thereafter, control proceeds to Step S400.

According to the flowchart in FIG. 13, the flooding destination address to be learned preferentially is determined based on a frequency of extractions of the flooding destination address, and causes the flooding destination address to be learned preferentially based on a determination result, thereby enabling to suppress flooding effectively.

### [c] Third Embodiment

A communication relay device according to a third embodiment of the present invention is explained next. In the communication relay device according to the third embodiment, a priority flag is set to the destination address output by the flooding-destination-address informing unit 210 according to the second embodiment, so that an SA matching the destination address having the priority flag is learned with the highest priority than other preferential learning SAs.

In the third embodiment, “having the priority flag” means a state that a flag is set. On the other hand, in the following explanations, a state that the flag 1 is not set is referred to as “does not have the priority flag”.

A communication relay device 300 according to the third embodiment has substantially the same functions as those of the communication relay device 200 depicted in FIG. 10, and detailed explanations of functional parts having the same functions as those of the communication relay device 200 according to the second embodiment will be omitted. The communication relay device 300 is explained below.

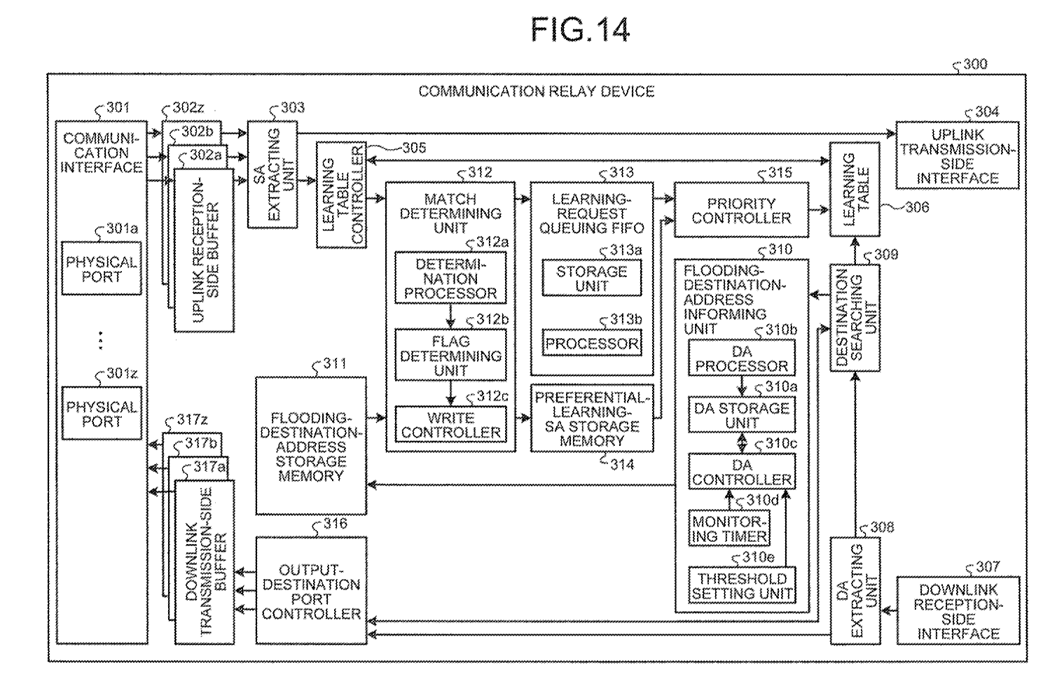

FIG. 14 is a schematic diagram for explaining the communication relay device according to the third embodiment. A communication interface 301 corresponds to the communication interface 201 depicted in FIG. 2, and for example, transmits and receives a frame to and from a terminal group connected to the communication relay device 300.

The communication interface 301 has physical ports 301a to 301z.

The port number is respectively allocated to each physical port as in the second embodiment. Details thereof are the same as the physical ports 201a to 201z of the second embodiment.

Uplink reception-side buffers 302a to 302z correspond to the uplink reception-side buffers 202a to 202z depicted in FIG. 10, and temporarily store a frame received from a terminal for adjusting the processing speed and transfer speed between terminals.

A source address (SA) held by a terminal and port number corresponding to the SA are included in a frame stored in the uplink reception-side buffer 302a to 302z.

An SA extracting unit 303 corresponds to the SA extracting unit 203 depicted in FIG. 10, and extracts the port number and the SA from the buffers for each frame and outputs the extracted frame including the port number and SA to the network via an uplink transmission-side interface 304.

In the following explanations, data including the port number and SA extracted from uplink reception-side buffers 303a to 303z by the SA extracting unit 303 is referred to as “frame S3” for descriptive purposes.

The uplink transmission-side interface 304 corresponds to the uplink transmission-side interface 204 depicted in FIG. 10, and transfers the frame S3 input from the SA extracting unit 303 to the network connected to the communication relay device 300.

A learning table controller 305 corresponds to the learning table controller 205 depicted in FIG. 10, determines whether data indicated by the frame S3 is stored in a learning table 306, and performs a learning process of the SA and port number included in the frame S3 according to a determination result.

Specifically, the learning table controller 305 determines whether the data indicated by the frame S3 matches any of data stored in the learning table 306. When the data matches any of data in the learning table 306, the learning table controller 305 determines that learning has been performed already, and does not output the SA and port number included in the frame S3 to a match determining unit 312.

On the other hand, when data matching data stored in the learning table 306 is not included in the frame S3, the learning table controller 305 outputs the SA and port number included in the frame S3 to the match determining unit 312.

The learning table 306 corresponds to the learning table 206 depicted in FIG. 10, and includes “port number” and “source address” depicted in FIG. 3, and a source address is stored in association with each port number.

A downlink reception-side interface 307 corresponds to the downlink reception-side interface 207 depicted in FIG. 10, and receives a frame to be transmitted to a terminal.

A DA extracting unit 308 corresponds to the DA extracting unit 208 depicted in FIG. 10, extracts a destination address (hereinafter, simply DA) from the frame transmitted to a terminal for each frame, and outputs the extracted DA to a destination searching unit 309 and an output-destination port controller 316.

The data including the DA extracted by the DA extracting unit 308 is referred to as “frame D3” for descriptive purposes.

The destination searching unit 309 corresponds to the destination searching unit 209 depicted in FIG. 10, and searches the learning table 306 whether data matching the data included in the frame D3 is stored in the learning table 306.

As a result of search, when data matching therewith is found, the destination searching unit 309 outputs the frame D3 including the port number corresponding to the DA to the output-destination port controller 316.

On the other hand, when data matching the data included in the frame D3 is not stored in the learning table 306, and search is not successful, the destination searching unit 309 outputs the frame D3 including the DA to a flooding-destination-address informing unit 310 as a frame addressed to an unlearned terminal.

A frame addressed to a terminal received by the downlink reception-side interface 307 and having a DA that does not match the SA stored in the learning table 306 is referred to as “frame addressed to an unlearned terminal”, and the DA included in the frame addressed to the unlearned terminal is referred to as “flooding destination address”.

The flooding-destination-address informing unit 310 determines a frequency of generations of a frame addressed to an unlearned terminal within a predetermined time, adds a priority flag to the frame D3 based on a determination result, and outputs the frame D3 together with the added priority flag to a flooding-destination-address storage memory 311.

The flooding-destination-address informing unit 310 includes a DA storage unit 310a, a DA processor 310b, a DA controller 310c, a monitoring timer 310d, and a threshold setting unit 310e.

The DA storage unit 310a corresponds to the DA storage unit 210a depicted in FIG. 10, and stores a frame addressed to an unlearned terminal output by the destination searching unit 309. “Destination address” depicted in FIG. 11 is stored therein.

The DA processor 310b corresponds to the DA processor 210b depicted in FIG. 10, and sequentially stores the frame D3 input from the destination searching unit 309 in the DA storage unit 310a.

The DA controller 310c determines the number of predetermined destination addresses stored in the DA storage unit 310a within a predetermined time, adds a priority flag based on a determination result, and stores the predetermined destination addresses in the flooding-destination-address storage memory 311 together with the added priority flag.

The monitoring timer 310d corresponds to the monitoring timer 210d depicted in FIG. 10, and outputs time information to the DA controller 310c. The time information indicates an effective time of the destination address as a determination target of the DA controller 310c.

The threshold setting unit 310e corresponds to the threshold setting unit 210e, and outputs threshold information for determining a frequency of generations of a frame addressed to an unlearned terminal to the DA controller 310c.

A process performed by the DA controller 310c is explained by exemplifying the DA storage unit 310a, the DA processor 310b, the DA controller 310c, the monitoring timer 310d, and the threshold setting unit 310e.

For example, a case that the flooding destination address to be searched is “10:11:12:13:14:5”, the time information set to the monitoring timer 310d is “10 seconds”, and the threshold information set to the threshold setting unit 310e is “2” is explained below.

In this case, when the destination address is searched four times in 8 seconds, the DA controller 310c adds the priority flag to the destination address “10:11:12:13:14:5” and port number, and outputs these to the match determining unit 312.

On the other hand, when the destination address is searched twice in 10 seconds, the DA controller 310c outputs the destination address “10:11:12:13:14:5” and port number to the match determining unit 312. At this time, the priority flag is not added to the data to be output.

In this manner, when the number of searches of the flooding destination address within the time information output by the monitoring timer 310d exceeds the threshold, the DA controller 310c adds the priority flag thereto and outputs the destination address to the match determining unit 312.

On the other hand, when the number of searches of the flooding destination address within the time information output by the monitoring timer 310d does not exceed the threshold, the DA controller outputs the destination address without adding the priority flag.

The flooding-destination-address storage memory 311 is explained next. The flooding-destination-address storage memory 311 corresponds to the flooding-destination-address storage memory 211 depicted in FIG. 10, and includes “flooding destination address” and “priority flag”. The “priority flag” is information indicating whether the flag 1 is set, and the details thereof will be described later.

The match determining unit 312 performs matching between data included in the frame S3 and data included in the frame D3. When these data match each other, the match determining unit 312 determines whether the priority flag is included in the matching frame D3.

When the priority flag is included therein, the match determining unit 312 writes the SA matching the DA included in the frame D3 in a preferential-learning-SA storage memory 314 so that the SA is learned first.

On the other hand, when the frame D3 does not include the priority flag, the match determining unit 312 writes the SA matching the DA included in the frame D3 in a learning-request queuing FIFO 313 without performing the process described above.

The process performed by the match determining unit 312 according to the third embodiment is explained with reference to a drawing indicating a data structure of the preferential-learning-SA storage memory 314. A case that the preferential-learning-SA storage memory 314 is formed of a FIFO is explained first, and then, a case that the preferential-learning-SA storage memory 314 is formed of a read only memory (RAM) is explained.

“10:11:12:13:14:5” and “A2:A3:A4:A5:A6” are mentioned as an example of the flooding destination address stored in the flooding-destination-address storage memory 311, and it is assumed here that the priority flag is added to “10:11:12:13:14:5”.

The match determining unit 312 includes a determination processor 312a, a flag determining unit 312b, and a write controller 312c. The determination processor 312a first acquires the frame S3 from the learning table controller 305 and the frame D3 from the flooding-destination-address storage memory 311.

The determination processor 312a then compares data in the frame D3 with data in the frame S3, and for example, when an SA matching the flooding destination address “10:11:12:13:14:5” is found, the determination processor 312a outputs the matching SA and port number to the flag determining unit 312b.

The flag determining unit 312b determines whether the flag 1 is set in the DA matching the input SA. When the flag 1 is set, the flag determining unit 312b issues a process command indicating that the input SA is to be learned first to the write controller 312c.

When an SA matching the DA having the priority flag is input, the write controller 312c performs writes in the preferential-learning-SA storage memory 314 so that the input SA is learned first.

On the other hand, when an SA matching a DA not having the priority flag is input, the write controller 312c performs writes in the learning-request queuing FIFO 313 without performing the process described above.

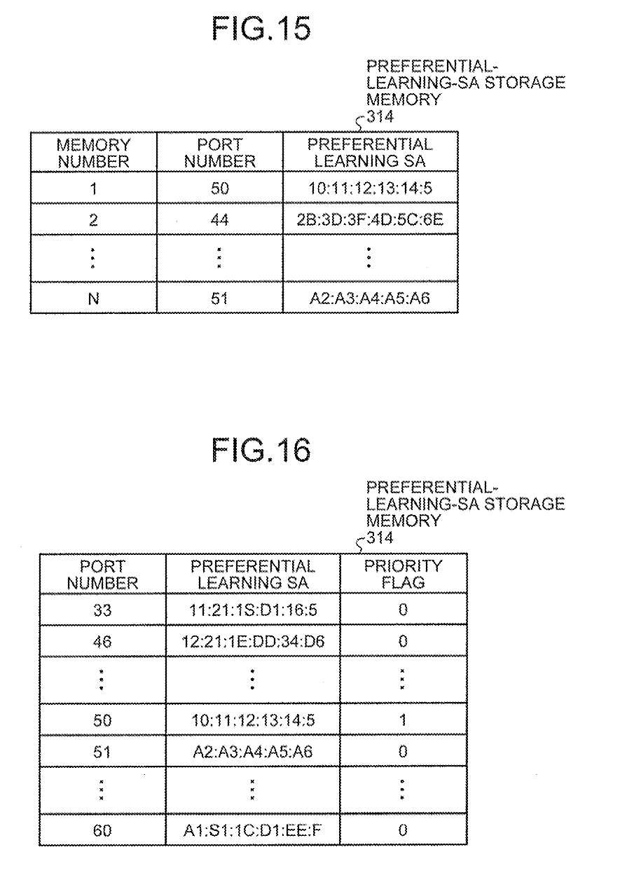

The process performed by the write controller 312c is explained by specifically exemplifying a data structure of the preferential-learning-SA storage memory 314. FIG. 15 is a schematic diagram for explaining an example of the data structure when the preferential-learning-SA storage memory 314 is formed of a FIFO.

The preferential-learning-SA storage memory 314 depicted in FIG. 15 stores “memory number”, “preferential learning SA”, and “port number”, and has a data structure such that learning in the learning table 306 is performed in order of memory number.

Therefore, the preferential learning SA stored in the memory number 1 is learned preferentially in the learning table 306 than the preferential learning SAs stored in the memory numbers 2 to N.

An example in which the preferential learning SA “10:11:12:13:14:5” is stored is explained first. In this case, before the preferential learning SA “10:11:12:13:14:5” is stored, a preferential learning SA of a port number 44 has been stored in the memory number 1 to be learned preferentially in the learning table 306.

The write controller 312c stores the preferential learning SA “10:11:12:13:14:5” acquired from the flag determining unit 312b, breaking into the memory number 1. As a result, the preferential learning SA “10:11:12:13:14:5” stored in the memory number 1 is learned in the learning table 306 more preferentially than the preferential learning SA stored in the memory number 2 onward.

On the other hand, when “A2:A3:A4:A5:A6” not having the priority flag is acquired from the flag determining unit 312b, the write controller 312c stores the acquired data in the largest memory number together with the port number.

For example, when the preferential learning SAs are stored in up to a memory number 4, the write controller 312c stores the acquired data in a memory number 5. In this case, data stored in the memory number 5 is learned in the learning table 306, after the preferential learning SAs stored in the memory numbers 1 to 4 have been learned in the learning table 306.

In this manner, upon acquisition of an SA matching data having the priority flag, the write controller 312c writes the SA in the memory number 1, and upon acquisition of an SA matching data not having the priority flag, the write controller 312c writes the data in the largest memory number.

Therefore, the “process command indicating that the input SA is to be learned first” indicates a process in which, for example, the top memory number in the preferential-learning-SA storage memory 314 is set to “1”, and the acquired SA is stored in the memory number 1.

The memory number to be learned first can be arbitrarily specified, and for example, a predetermined memory number such as the memory number 1 or the memory number 2 can be specified.

For example, when a memory number 10 is specified, the preferential learning SA stored in the memory number 10 is learned in the learning table 306 more preferentially than the preferential learning SA stored in other memory numbers.

A case that the preferential-learning-SA storage memory 314 is formed of a RAM is explained next. FIG. 16 is a schematic diagram for explaining an example of the data structure when the preferential-learning-SA storage memory 314 is formed of a RAM.

The preferential-learning-SA storage memory 314 depicted in FIG. 16 stores “port number”, “preferential learning SA”, and “priority flag”, and “0” stored in a priority flag indicates that the flag 1 is not set, and “1” indicates that the flag 1 is set.

As depicted in FIG. 16, it is assumed that preferential learning SAs corresponding to port numbers 33, 46, 60 and the like have been already stored, and an example in which “10:11:12:13:14:5” and “A2:A3:A4:A5:A6” are acquired by the match determining unit 312 from the flooding-destination-address storage memory 311 is explained. In this case, it is assumed that the priority flag is added to “10:11:12:13:14:5”.

The determination processor 312a first acquires the frame S3 from the learning table controller 305, and the frame D3 from the flooding-destination-address storage memory 311.

The determination processor 312a then compares data in the frame S3 with data in the frame D3, and for example, and outputs an SA matching the flooding destination address “10:11:12:13:14:5” and information indicating whether 0 or 1 is set in the priority flag to the flag determining unit 312b.

The flag determining unit 312b determines whether the priority flag is added to the DA corresponding to the input SA. Because the priority flag is added to the flooding destination address “10:11:12:13:14:5”, the flag determining unit 312b outputs the input SA to the write controller 312c together with a priority flag “1” and port number.

The write controller 312c writes “10:11:12:13:14:5”, a port number 50, and the priority flag “1” in the preferential-learning-SA storage memory 314.

In this case, different from the example depicted in FIG. 15, the information need not be written in the memory number 1, and can be written in an arbitrary memory number. In FIG. 16, an example in which “10:11:12:13:14:5” is written in a memory number 50 is depicted.

On the other hand, the flag determining unit 312b outputs an SA matching the flooding destination address “A2:A3:A4:A5:A6” to the write controller 312c together with a priority flag “0” and a port number.

The write controller 312c writes “A2:A3:A4:A5:A6”, the priority flag “0”, and a port number “51” in the preferential-learning-SA storage memory 314.

Returning to the explanation of FIG. 14, a priority controller 315 is explained. The priority controller 315 performs a different process for a case that the preferential-learning-SA storage memory 314 is formed of the FIFO and a case that the preferential-learning-SA storage memory 314 is formed of the RAM. Therefore, a case that the preferential-learning-SA storage memory 314 is formed of the FIFO is explained first, and then a case that the preferential-learning-SA storage memory 314 is formed of the RAM is explained.

There is explained a case that the preferential-learning-SA storage memory 314 is formed of the FIFO, and the memory number to be learned in the learning table 306 first is set to 1. In this case, the priority controller 315 causes the preferential learning SA written in the memory number 1 in the preferential-learning-SA storage memory 314 to be learned in the learning table 306 more preferentially than other preferential learning SAs.

When the memory number to be learned first in the learning table 306 is set to an arbitrary memory number, the priority controller 315 searches whether the preferential learning SA is written in the set memory number, and when the preferential learning SA is written therein, the priority controller 315 causes the preferential learning SA to be learned in the learning table 306.

Subsequently, a process performed by the priority controller 315 when the preferential-learning-SA storage memory 314 is formed of the RAM is explained. In this case, the priority controller 315 searches whether there is data added with the priority flag “1” from data stored in the preferential-learning-SA storage memory 314.

When a preferential learning SA having the priority flag “1” is found, the priority controller 315 causes the searched preferential learning SA to be learned in the learning table 306 more preferentially than other preferential learning SAs. When the preferential learning SA having the priority flag “1” is not found, the priority controller 315 causes other preferential learning SAs to be learned sequentially in the learning table 306.

The output-destination port controller 316 corresponds to the output-destination port controller 216 depicted in FIG. 10, and determines an output destination port based on the frame input from the destination searching unit 309, and allocates the port.

Downlink transmission-side buffers 317a to 317z correspond to the downlink transmission-side buffers 217a to 217z depicted in FIG. 10, temporarily store a frame to be transmitted to a terminal for adjusting the processing speed and transfer speed between terminals, and include a frame including a DA addressed to the terminal.

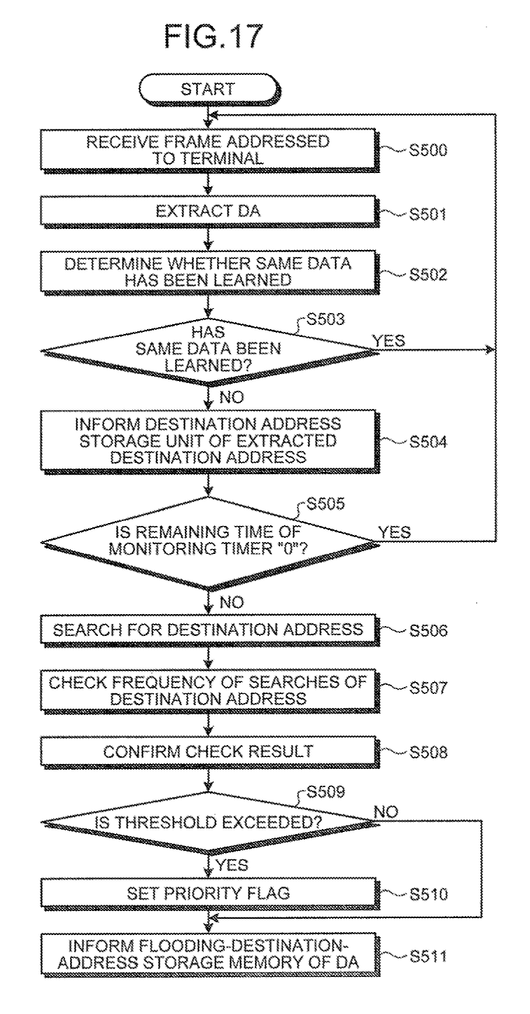

A process procedure performed by the flooding-destination-address informing unit 310 is explained next. FIG. 17 is a flowchart of a process performed by the flooding-destination-address informing unit according to the third embodiment.

After the downlink reception-side interface 307 receives a frame addressed to a terminal (Step S500), the DA extracting unit 308 first extracts the frame D3 from the frame addressed to the terminal received at Step S500 (Step S501).

The destination searching unit 309 determines whether data same as the frame D3 extracted at Step S501 has been learned in the learning table 306 (Step S502). When the data has been learned in the learning table 306 (YES at Step S503), control proceeds to Step S500.

On the other hand, when the data has not been learned in the learning table 306 (NO at Step S503), the destination searching unit 309 informs the DA processor 310b of the frame D3 extracted at Step S501. The DA processor 310b outputs the informed data to the DA storage unit 310a (Step S504).

When a remaining time in the time information input from the monitoring timer 310d is not “0” (NO at Step S505), the DA controller 310c starts searching for a DA stored at the top of the DA storage unit 310a (Step S506).

On the other hand, when the remaining time in the time information input from the monitoring timer 310d is “0” (YES at Step S505), control proceeds to Step S500.

The DA controller 310c confirms a frequency of searches of the DA at Step S506 (Step S507), and determines whether the frequency of searches of the DA exceeds the threshold information input from the threshold setting unit 310e (Step S508).

When having determined that the threshold is exceeded (YES at Step S509), the DA controller 310c adds a priority flag to the frame D3 as a determination target (Step S510), and outputs the frame D3 to the flooding-destination-address storage memory 311 (Step S511).

On the other hand, when having determined that the threshold is not exceeded (NO at Step S509), the DA controller 310c outputs the frame D3 as the determination target to the flooding-destination-address storage memory 311 without adding the priority flag (Step S511).

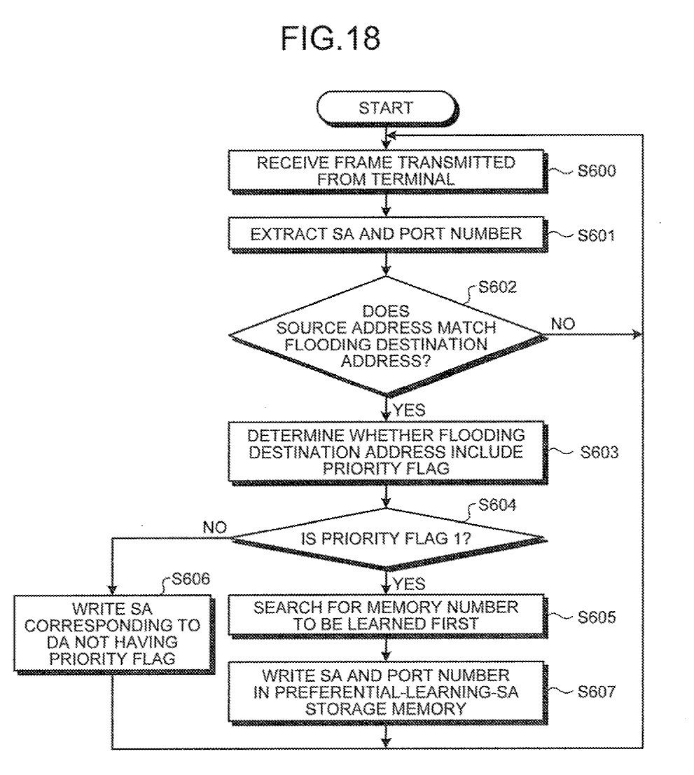

A process procedure performed by the match determining unit 312 when the preferential-learning-SA storage memory is formed of a FIFO is explained next. FIG. 18 is a flowchart of a process performed by the match determining unit when the preferential-learning-SA storage memory is formed of a FIFO.

The communication interface 301 first receives a frame transmitted from a terminal (Step S600). The SA extracting unit 303 extracts an SA and port number from the frame received at Step S600 (Step S601).

The match determining unit 312 determines whether the SA extracted at Step S601 matches the DA stored in the flooding-destination-address storage memory 311. When the SA matches the DA (YES at Step S602), the match determining unit 312 determines whether the flooding destination address corresponding to the matching SA includes a priority flag (Step S603).

When the flooding destination address includes the priority flag (YES at Step S604), the match determining unit 312 searches the preferential-learning-SA storage memory 314 for the memory number to be learned first (Step S605).

The match determining unit 312 writes the SA extracted at Step S601 and port number in the memory number searched at Step S605 (Step S607).

On the other hand, when the flooding destination address does not include a priority flag (NO at Step S604), the match determining unit 312 writes the SA and port number acquired at Step S601 in the preferential-learning-SA storage memory 314 (Step S606).

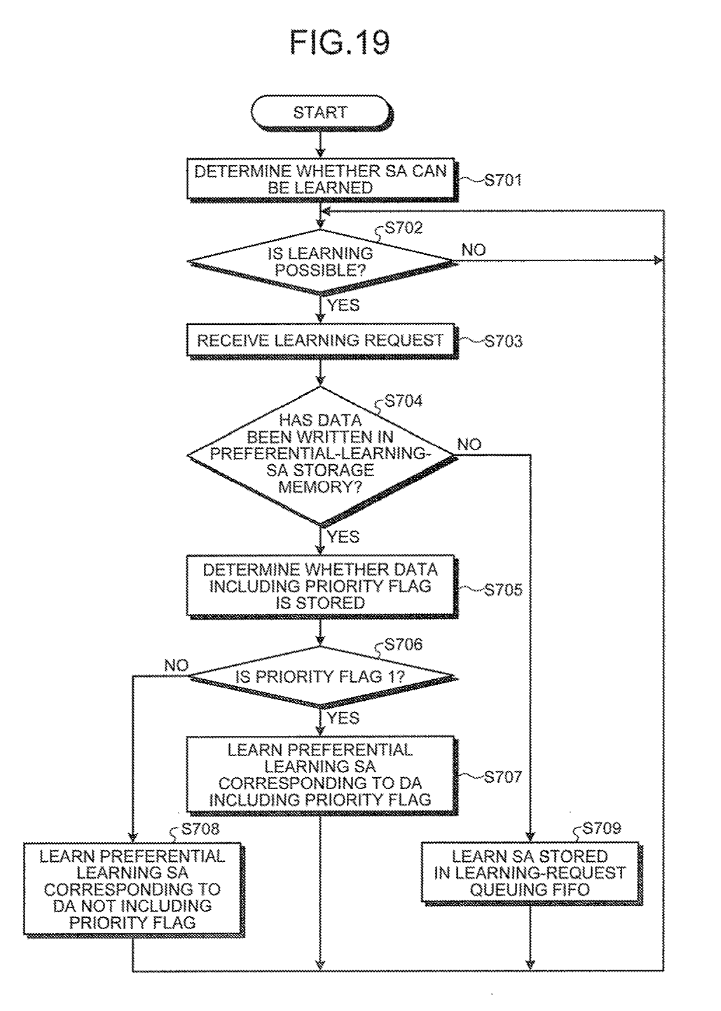

A process procedure performed by the priority controller 315 when the preferential-learning-SA storage memory 314 is formed of a RAM is explained next. FIG. 19 is a flowchart of a process performed by the priority controller when the preferential-learning-SA storage memory is formed of a RAM.

The priority controller 315 first determines whether an SA can be learned in the learning table 306 based on a memory capacity of the learning table 306 (Step S701).

When a new SA is to be learned in the learning table 306 (YES at Step S702), the priority controller 315 receives a learning request with respect to the learning table 306 (Step S703).

When the data has been written in the preferential-learning-SA storage memory 314 (YES at Step S704), the priority controller 315 determines whether data including a priority flag is stored (Step S705).

When the data including the priority flag is stored (YES at Step S706), the priority controller 315 causes the preferential learning SA corresponding to the DA including the priority flag to be learned in the learning table 306 (Step S707).

On the other hand, when the data including the priority flag is not stored (NO at Step S706), the preferential learning SA stored in the preferential-learning-SA storage memory 314 is learned in the learning table 306 (Step S708).

When the data is not stored in the preferential-learning-SA storage memory 314 (NO at Step S704), the priority controller 315 causes the SA stored in the learning-request queuing FIFO 313 to be learned in the learning table 306 (Step S709).

Effects when the communication relay device 300 according to the third embodiment is used are explained next. For explaining a difference from the conventional technique, an output rate of a port 1 included in the communication relay device 50 is explained as an example.

A precondition of the communication relay device 50 is explained first. It is assumed that the communication relay device 50 includes eight physical ports respectively for input and output, and SAs with respect to all packets have not been learned yet in the learning table 56. It is also assumed that the respective packets have arrived at the communication interface 51 in the following orders.

The respective packets arrive in order of a time 0: no arrival packet, a time 1: a packet (1) arrives at the port 1, a time 2: a packet (2) arrives at a port 2, a time 3: a packet (3) arrives at a port 3, a time 4: a packet (4) arrives at a port 4, a time 5: a packet (5) arrives at a port 5, a time 6: a packet (6) arrives at a port 6, a time 7: a packet (7) arrives at a port 7, and a time 8: a packet (8) arrives at a port 8.

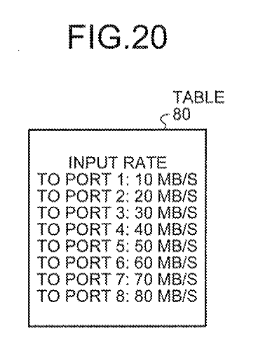

An input rate on the downlink reception side of the communication relay device 50 is depicted in FIG. 20. FIG. 20 is a schematic diagram for explaining the input rate. As depicted in table 80 in FIG. 20, it is assumed that an input rate to the port 1 is 10 megabyte per second (MB/S), an input rate to the port 2 is 20 MB/S, an input rate to the port 3 is 30 MB/S, an input rate to the port 4 is 40 MB/S, an input rate to the port 5 is 50 MB/S, an input rate to the port 6 is 60 MB/S, an input rate to the port 7 is 70 MB/S, and an input rate to the port 8 is 80 MB/S. Accordingly, a total input rate of the communication relay device is 360 megabytes (MB).

It is assumed that packets to respective ports are input hourly to the downlink reception side, and a band of an output port on a downlink transmission side is 100 MB/S. Under such conditions, an hourly output rate on the downlink transmission side is explained, using the port 1 as an example.

It is assumed that a source address of a packet other than those described above is stored in the learning-request queuing FIFO 55.

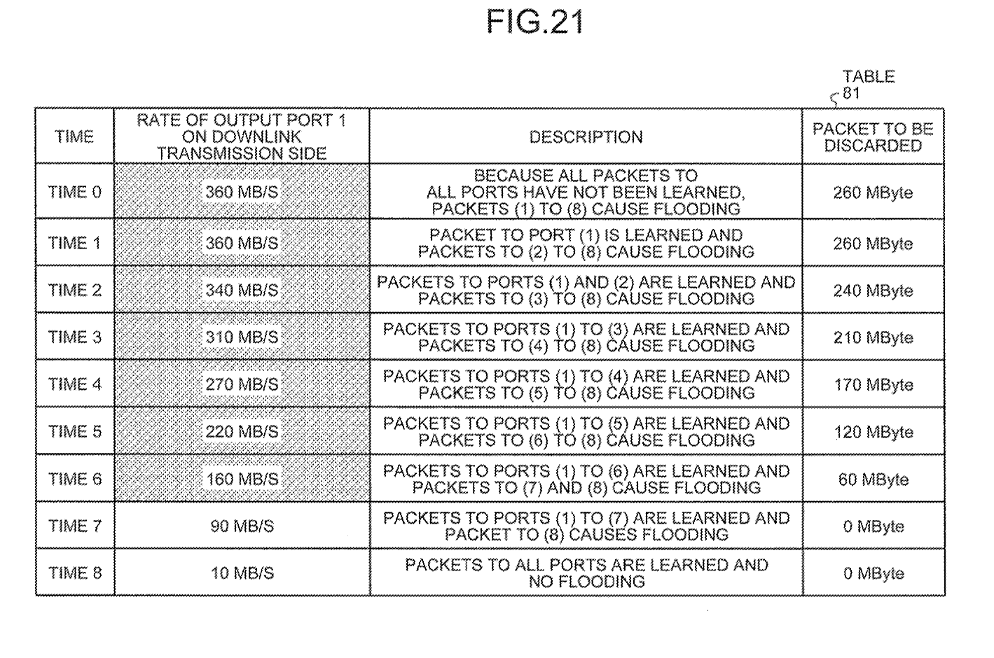

FIG. 21 is a schematic diagram for explaining the output rate to the port 1 in the conventional technique. As depicted in table 81 in FIG. 21, because the communication relay device 50 performs a learning process in order of arrival of the packets (1) to (8), the order to be learned in the learning table 56 becomes such that the packet (1) is learned first, and the packet (8) is learned last among the packets (1) to (8).

In this case, because packets to all ports have not been learned at the time 0, the packets (1) to (8) cause flooding. Accordingly, the packets (1) to (8) are output from the port 1.

As a result, a data input of 360 MB/S is generated at the port 1 with respect to the output rate of 100 MB/S of the port 1. As a result, at the output port 1 on the downlink transmission side, data of 260 MB is discarded.

Subsequently, at the time 1, an SA and port number included in the packet (1) are learned, and the packet (1) is output from the port 1. In this case, the packets (1) to (8) are output from the port 1.

As a result, a data input of 360 MB/S is generated at the port 1 with respect to the output rate of 100 MB/S of the port 1. As a result, at the output port 1 on the downlink transmission side, data of 260 MB is discarded.

Subsequently, at the time 2, SAs and port numbers included in the packets (1) and (2) are learned, the packet (1) is output from the port 1, and the packet (2) is output from the port 2. In this case, the packet (1) and the packets (3) to (8) are output from the port 1.

As a result, data of input rate 10 MB/S to the port 1 and input rate 330 MB/S to ports 3 to 8, in total, data of 340 MB/S is generated at the port 1 with respect to the output rate of 100 MB/S of the port 1, and thus, at the output port 1 on the downlink transmission side, data of 240 MB is discarded.

Subsequently, at the time 3, SAs and port numbers included in the packets (1) to (3) are learned, the packet (1) is output from the port 1, the packet (2) is output from the port 2, and the packet (3) is output from the port 3. In this case, the packet (1) and the packets (4) to (8) are output from the port 1.

As a result, data of input rate 10 MB/S to the port 1 and input rate 300 MB/S to ports 4 to 8, in total, data of 310 MB/S is generated at the port 1 with respect to the output rate of 100 MB/S of the port 1, and thus, at the output port 1 on the downlink transmission side, data of 210 MB is discarded.

Subsequently, at the time 4, SAs and port numbers included in the packets (1) to (4) are learned, the packet (1) is output from the port 1, the packet (2) is output from the port 2, the packet (3) is output from the port 3, and the packet (4) is output from the port 4. In this case, the packet (1) and the packets (5) to (8) are output from the port 1.

As a result, data of input rate 10 MB/S to the port 1 and input rate 260 MB/S to ports 5 to 8, in total, data of 270 MB/S is generated at the port 1 with respect to the output rate of 100 MB/S of the port 1, and thus, at the output port 1 on the downlink transmission side, data of 170 MB is discarded.

Subsequently, at the time 5, SAs and port numbers included in the packets (1) to (5) are learned, the packet (1) is output from the port 1, the packet (2) is output from the port 2, the packet (3) is output from the port 3, the packet (4) is output from the port 4, and the packet (5) is output from the port 5. In this case, the packet (1) and the packets (6) to (8) are output from the port 1.

As a result, data of input rate 10 MB/S to the port 1 and input rate 210 MB/S to ports 6 to 8, in total, data of 220 MB/S is generated at the port 1 with respect to the output rate of 100 MB/S of the port 1, and thus, at the output port 1 on the downlink transmission side, data of 120 MB is discarded.

Subsequently, at the time 6, SAs and port numbers included in the packets (1) to (6) are learned, the packet (1) is output from the port 1, the packet (2) is output from the port 2, the packet (3) is output from the port 3, the packet (4) is output from the port 4, the packet (5) is output from the port 5, and the packet (6) is output from the port 6. In this case, the packet (1) and the packets (7) to (8) are output from the port 1.

As a result, data of input rate 10 MB/S to the port 1 and input rate 150 MB/S to ports 7 to 8, in total, data of 160 MB/S is generated at the port 1 with respect to the output rate of 100 MB/S of the port 1, and thus, at the output port 1 on the downlink transmission side, data of 60 MB is discarded.

Subsequently, at the time 7, SAs and port numbers included in the packets (1) to (7) are learned, the packet (1) is output from the port 1, the packet (2) is output from the port 2, the packet (3) is output from the port 3, the packet (4) is output from the port 4, the packet (5) is output from the port 5, the packet (6) is output from the port 6, and the packet (7) is output from the port 7. In this case, the packet (1) and the packet (8) are output from the port 1.

As a result, data of input rate 10 MB/S to the port 1 and input rate 80 MB/S to the port 8, in total, data of 90 MB/S is generated at the port 1 with respect to the output rate of 100 MB/S of the port 1, and there is no data discarded at the output port 1 on the downlink transmission side.

In this manner, in the conventional communication relay device 50, it is at the time 7 that there is no data discarded at the output port 1 on the downlink transmission side. The amount of packets discarded by the time 7 becomes 1320 MB in total.

Effects of the third embodiment are explained next by exemplifying the communication relay device 300 according to the third embodiment. A precondition for explaining effects of the third embodiment is explained first.

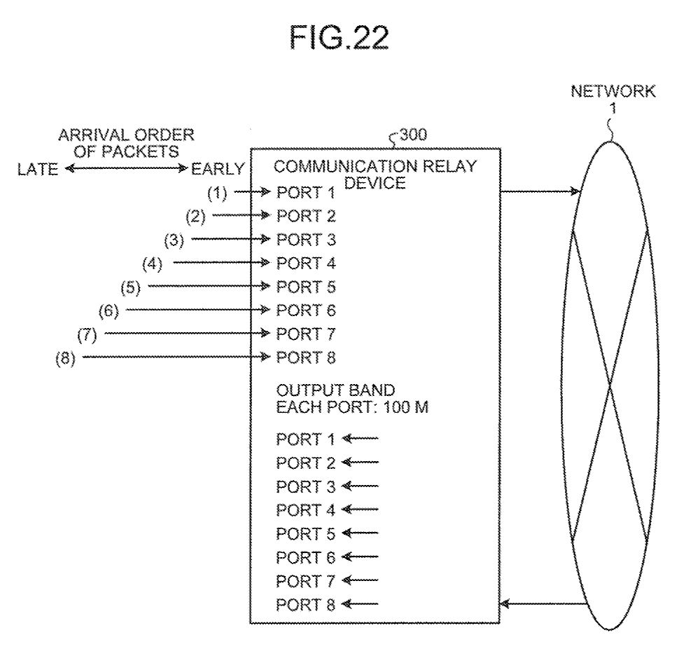

FIG. 22 is a schematic diagram for explaining the precondition for explaining effects of the present invention. An output rate of the port 1 included in the communication relay device 300 is explained as an example. It is assumed here that the communication relay device 300 is connected to a network 1 and includes 8 physical ports respectively for input and output, and SAs and port numbers with respect to all packets have not been learned yet in the learning table 306.

It is also assumed that respective packets have arrived at the communication interface 301 in an order depicted below. In the communication relay device 300 depicted in FIG. 22, although the port 1 to the port 8 are described vertically for convenience' sake of explanation, these indicate the same port.

The respective packets arrive in order of the time 0: no arrival packet, the time 1: the packet (1) arrives at the port 1, the time 2: the packet (2) arrives at the port 2, the time 3: the packet (3) arrives at the port 3, the time 4: the packet (4) arrives at the port 4, the time 5: the packet (5) arrives at the port 5, the time 6: the packet (6) arrives at the port 6, the time 7: the packet (7) arrives at the port 7, and the time 8: the packet (8) arrives at the port 8.

It is assumed that the input rates on the downlink reception side of the communication relay device 300 have the same values as those depicted in FIG. 20. Under such conditions, effects when the communication relay device according to the third embodiment is used are explained below.

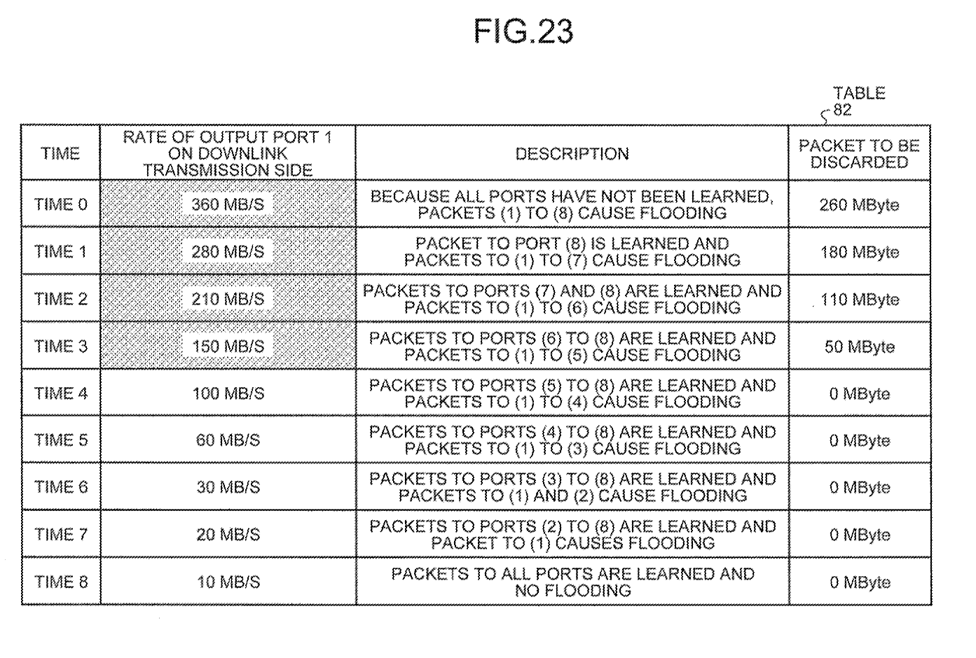

FIG. 23 is a schematic diagram for explaining effects of embodiments of the present invention. When the communication relay device 300 according to the third embodiment is used, because flooding frequency of a frame increases as the input rate on the downlink reception side becomes high, an SA is extracted as a flooding destination address having a high priority.

Accordingly, in the input rates to the ports 1 to 8, because the input rate to the port 8 is 80 MB/S and flooding frequency of the packet (8) increases, an SA matching a DA included in the packet (8) is extracted as a flooding destination address having a high priority.

The extracted SA is stored in the flooding-destination-address storage memory 311, and the SA corresponding to the packet (8) is written in the preferential-learning-SA storage memory 314 by the process performed by the match determining unit 312.

The SA is learned more preferentially than other SAs. If it is assumed that SAs are learned in descending order of input rate on the downlink reception side, packets are learned in order of the packets (8), (7), (6), (5), (4), (3), (2), and (1).

As a result, the time at which the output rate 100 MB/S of the port 1 on downlink output side is not exceeded becomes the time “4”, and the total amount of packets discarded at the port 1 by the time 4 becomes 600 MB.

Thus, in the conventional technique, it is at the time 7 that the output rate 100 MB/S of the output port 1 on the downlink transmission side is not exceeded and the packets discarded are 1320 MB, whereas in the third embodiment, the output rate 100 MB/S is reached at the time 4, the packets discarded are 600 MB.

Accordingly, flooding can be suppressed earlier and the packet discarded can be reduced by using the communication relay device 300 according to the third embodiment.

When it takes time until all learning requests of other frames extracted before being written in the learning table of the communication relay device are registered in the learning table, frames addressed to an unlearned terminal are continuously generated while queuing.

In this case, extra traffic is increased and thus the band is put under pressure. When the band held by each port exceeds a transferable amount due to the pressure, frames may be discarded.

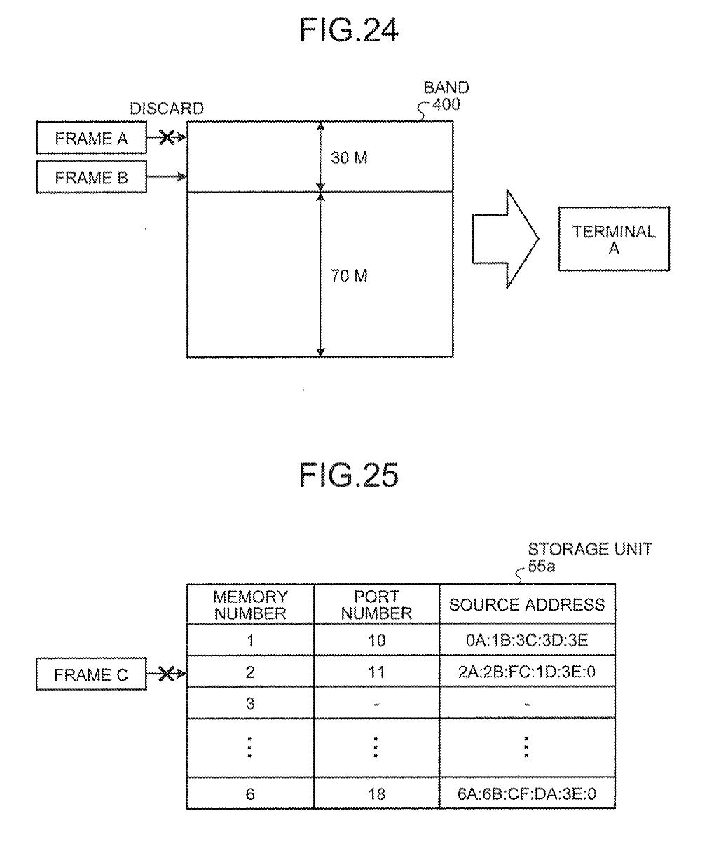

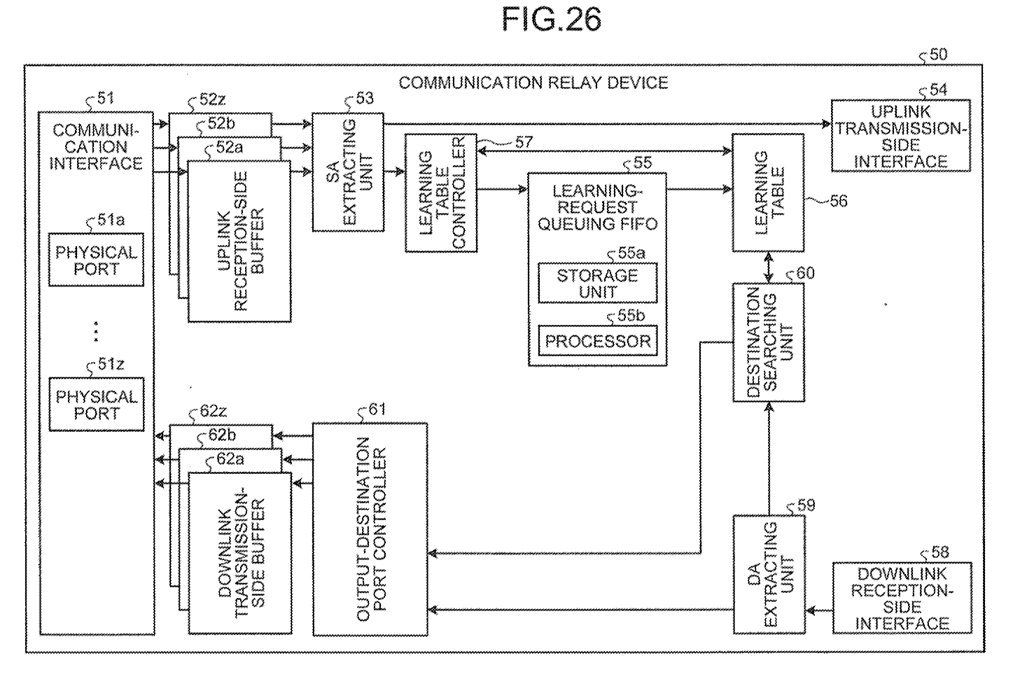

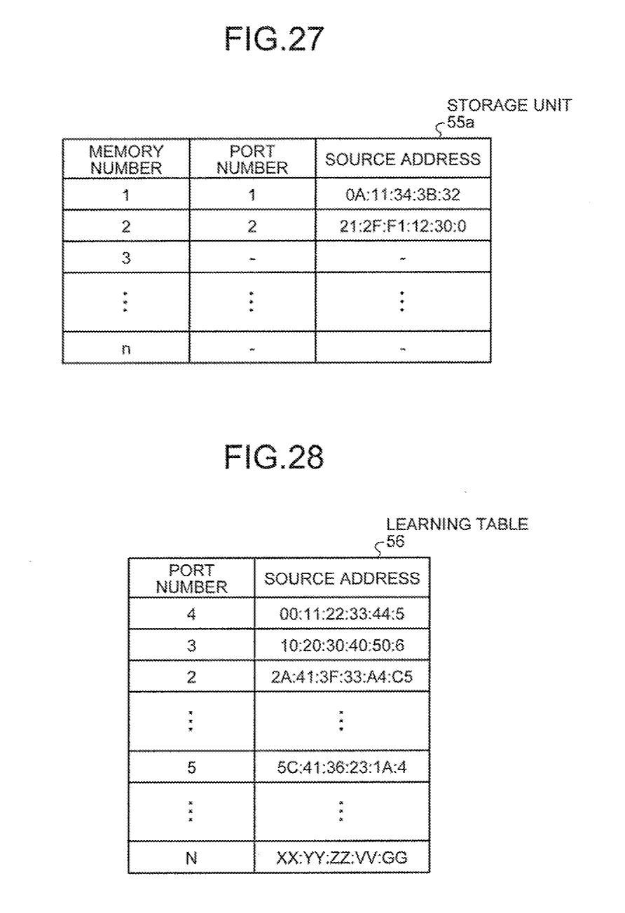

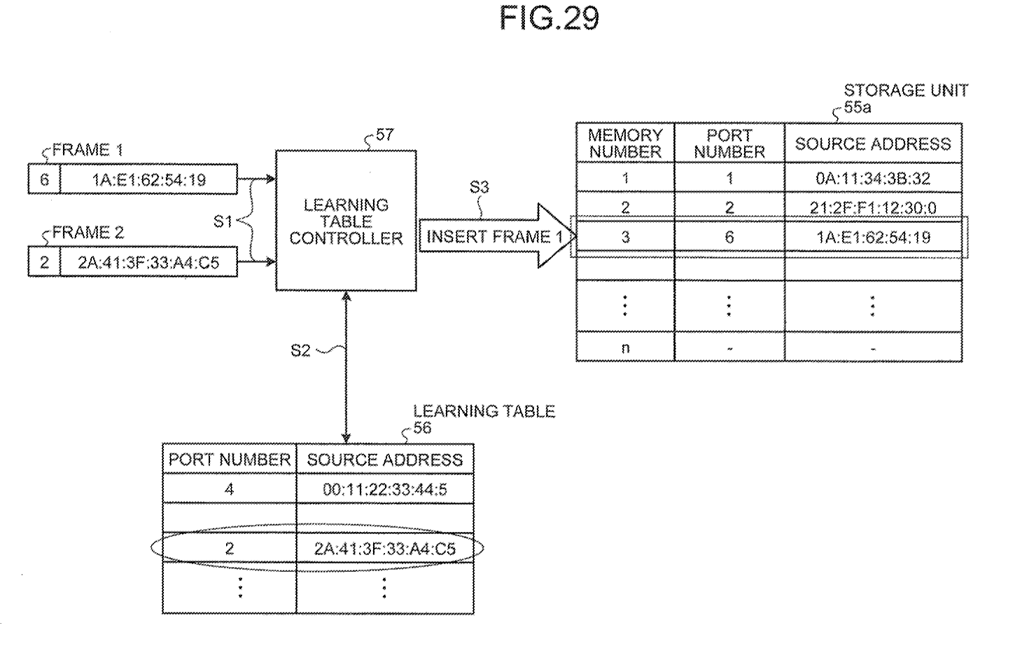

This is explained specifically with reference to FIG. 24. FIG. 24 is a schematic diagram for explaining discarding of a frame. As an example of use of a band 400 depicted in FIG. 24, a band to be used for transferring a unicast frame is given the highest priority, and remaining bands are used for transferring frames addressed to unlearned terminals.

For example, when 70 MB is used for transferring a unicast frame with respect to a band capable of transferring 100 MB, remaining 30 MB band can be used for transferring a frame addressed to an unlearned terminal.

It is assumed that frames A and B are continuously transmitted to a port as frames addressed to two different unlearned terminals using 30 MB band. The frame A is designated as a frame addressed to terminal A connected to the port, and the frame B is designated as a frame addressed to a terminal other than terminal A.

Because the remaining band is only 30 MB, when any one of the frames A and B uses the band, a frame that does not use the band is discarded because of exceeding the transferable amount of the band.

As a result, when the frame using the remaining 30 MB of the band 400 is the frame B, and the discarded frame is the frame A, the frame A to be transferred originally to terminal A is discarded.

In this case, for example, the communication relay device 100 according to the first embodiment causes a flooding address to be learned in the learning table 106 instantaneously, thereby enabling to transfer a frame only between connected terminals.

For example, if an SA corresponding to the frame B depicted in FIG. 24 is learned preferentially in the learning table 106, flooding is suppressed, and the frame B is not transferred to a port other than the connected port, and thus the frame A depicted in FIG. 24 can use the remaining band.

The learning-request queuing FIFO is provided to have durability against continuous learning requests. However, because the number that can be stored in the FIFO is limited, if learning requests are continuous, the capacity of the FIFO may become full.

For example, if a learning request is generated in this state, even if an unlearned source address for suppressing flooding is extracted, the learning request may be discarded.

This is explained specifically with reference to FIG. 25. FIG. 25 is a schematic diagram for explaining discarding of a learning request. If the capacity of the storage unit 55a depicted in FIG. 25 is a capacity to be stored in the memory numbers 1 to 2, even if it is tried to store a frame C, there is no enough capacity to store the frame C, and the frame C is discarded.

Even in this case, if it is determined whether an address is an unlearned source address for suppressing flooding, and only a source address to be learned in the learning table preferentially is stored therein and learned in the learning table, discarding of the learning request can be prevented.

According to the frame relay device disclosed by the present application, when a frame is received from a terminal having a destination address which causes flooding, the flooding can be suppressed by preferentially learning the destination address preferentially.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A frame relay device comprising:
a plurality of ports for receiving frames;
a learning table in which source addresses of the received frames to be transmitted to a network are registered in association with the ports;
an output-destination allocating unit that allocates a frame received from the network to a destination port by referring to the learning table;
a storage unit that searches the learning table whether a destination address of a frame received from a network is registered in the learning table, and stores therein an unregistered one of the destination address; and
a priority control unit that determines whether a source address of a frame received from the port is stored in the storage unit, and registers a source address stored in the storage unit in the learning table more preferentially than a source address not stored in the storage unit.

2. The frame relay device according to claim 1, further comprising a determining unit that counts a frequency of receptions of the destination address within a specified time when the destination address is stored in the storage unit, and determines whether a counted frequency is equal to or larger than a threshold, wherein
the destination address is stored in the storage unit based on a determination result of the determining unit.

3. The frame relay device according to claim 2, wherein the priority control unit counts a frequency of receptions of the destination address within a specified time, and registers a source address corresponding to a destination address with a counted frequency being equal to or larger than a threshold, among source addresses stored in the storage unit, preferentially in the learning table.

4. A frame relay method performed by a frame relay device that includes a plurality of ports for receiving frames; a learning table in which source addresses of the received frames to be transmitted to a network are registered in association with the ports; and an output-destination allocating unit that allocates a frame received from the network to a destination port by referring to the learning table, the frame relay method comprising:
searching the learning table whether a destination address of a frame received from a network is registered in the learning table;
storing in a storage unit an unregistered one of the destination address;
determining whether a source address of a frame received from the port is stored in the storage unit; and
registering a source address stored in the storage unit in the learning table more preferentially than a source address not stored in the storage unit.
